(19) United States
(12) Patent Application Publication
(10) Pub. No.: US 2002/0073089 A1
(43) Pub. Date: Jun. 13, 2002

(54) Method and system for creating and managing relational data over the internet

(76) Inventors: Andrew Schwartz, Gaithersburg, MD (US); William K. Jones, Laytonsville, MD (US); Michelle R. Ugas, Silver Spring, MD (US); Ta-Jen Hu, Rockville, MD (US)

Correspondence Address: NEEDLE & ROSENBERG, P.C., The Candle Building, Suite 1200, 127 Peachtree Street, N.E., Atlanta, GA, 30303-1811, US

(21) Appl. No.: 09/969,506

(22) Filed: Oct. 1, 2001

Related U.S. Application Data
(60) Provisional application No. 60/236,508, filed on Sep. 29, 2000.

(51) Int. Cl. G06F 7/00

(52) U.S. Cl. 707/10

(57) ABSTRACT

A database management system for the creation and management of relational data over a network. The database management system includes one or more remote or local database storage facilities and a database server computer executing a database server application that manages access to one or more database storage facilities through the network. The server computer is in communication with the one or more remote or local database storage facilities. The database management system further has a computer workstation in communication with the server computer, wherein the computer workstation executes a remote accessing program in the form of a web browser to access via the server computer data stored in the one or more remote database storage facilities.

### CROSS-REFERENCE TO RELATED PATENT APPLICATION

This application claims the benefit, pursuant to 35 U.S.C. § 120, of provisional U.S. patent application Ser. No. 60/236,508, filed Sep. 29, 2000, entitled “SYSTEM AND METHOD OF CREATING AND MANAGING RELATIONAL DATA OVER A NETWORK.”

### BACKGROUND OF THE INVENTION

1. Field of the Invention

The present invention relates to a system and method of data management. More specifically, the present invention relates to a system and method of creating and managing relational data over a network even if a user has little or no prior knowledge of database management systems.

2. Background

Database management systems are special data-processing systems or parts of data-processing systems that are developed to aid in the storage, manipulation, reporting and managing of data. They may be considered as building blocks in the construction of a data-processing system that also acts as a mechanism for the effective control of the data. The database management system provides a means for management of data by making data available to a large range of authorized users, while preserving the integrity of the data and improving the performance of the system.

Database management systems are a necessity in today's Information Age. It has been estimated that a medium-sized corporation may need to retain 10¹⁰ characters of current important data in high-speed automated storage. The size and complexity of data demand a database management system that not only can store the data, but also can allow users to access and find needed data.

Data only becomes truly available when a large cross section of potential users know of its existence, when its location and format are known, and when there is a mechanism for retrieving the data. If the mechanism to locate its format is used by humans, the location is normally termed a directory, while the format is stored in a data dictionary. If the locating device is embedded in the database management system, the mechanism is termed a schema.

Different database management systems may use different schemas and model the data in different ways. Currently, there are three types of database management systems in general. The three types of database management systems are relational, hierarchical and network systems.

The relational system represents stored data as tables. Tables are identified by their names and are comprised of columns and rows. Columns may contain the column name, data type and any other attributes of the column. Rows may contain the data for the appropriate columns to which the data is assigned. No entry in the table contains more than one elementary value (for example, it would be impossible to have two dates of birth for John Doe).

The hierarchical system allows for more structure. In the hierarchical system, groupings of elements are connected by parent-child relationships. For example, a particular person may have one or several different educational categories (high school, bachelor's degree, master's degree, and so forth), as well as several job histories (office boy, clerk, manager, president, and so forth).

A network system has more structure and complexity, because it uses named relationships. Because these three types of systems are structurally different, most current commercial database management systems can only provide for one type of data service among the three.

Database server computers are specialized computers that are used to dole out database data to computer workstations. Traditional database management systems download all the data that is contained in a database to a workstation and accordingly permit the database management system that is running on the workstation to sort through the data in order to pick out the information that the application needs. In comparison, a database server computer runs a database application that selects the needed information and summarily transmits only the selected data to the workstation. Thus, a database server computer allows for vastly less network traffic within a multi-user database system. Additionally, since a single computer is responsible for all of the record and file locking, data integrity of stored data is greatly improved.

The database management system of the present invention utilizes various incarnations of data, including but not limited to views, tables and aliases. A view is a particular visual way of looking at a database. Databases can support numerous different views. In most instances a view arranges the records in some order and makes only certain fields visible. The physical organization of the database is not affected by the various views that a database management system may support.

As mentioned above, a table refers to stored data that is arranged in rows and columns. In a relational database management system, all information is stored in the form of tables. Lastly, an alias is an alternative name for an object, such as a table.

The standard language utilized for communication within relational database management systems is Structured Query Language (SQL). SQL statements or commands in SQL may be utilized to perform such database management tasks such as the retrieval of data from a database or updating data on a database. Standard SQL statements can be used to accomplish extensive database management operations across various platforms of currently available commercial database management systems.

Most current database management systems require users to have some knowledge about the data management system a particular user is using, this may potentially limit the use of the data management system. Furthermore, most current data management systems often create customer-oriented applications, which may further limit the accessibility of the data.

Thus, there is a need to develop new database management systems and methods for storing and managing data, especially in a network environment such as the Internet.

### SUMMARY OF THE INVENTION

In one aspect, the present invention provides a database management system that consolidates many useful DB2 functions in a single place, with an easy-to-use Internet web browser front end. For example, after creating new tables for data or updating existing ones, a user can see the results in Excel™. The database management system of the present invention can be easily accessed from a system user's Internet web browser at a predetermined Internet web site.

In one embodiment of the present invention, a user is allowed to navigate through a database, such as a DB2 catalog, by pointing and clicking a system input device, such as a mouse, in conjunction with a displayed HTML system navigation form. The navigation form displays to the user only those tables for which the user is authorized access. Additionally, the user can enter partial table names for finding tables that start with certain characters or leave the table name blank to see all tables.

A further embodied feature of the system allows for the display of columns that are contained within a table, including their data types, and the addition of columns to a table without the user having to write and enter SQL statements to the system. Moreover, the system can display the indexes defined on a table and drill down to the columns that make up an index in addition to displaying view definitions.

Security aspects in regard to the database management system of the present invention are addressed through the system's ability to display the existing privileges of a user's tables. Accordingly, a user may grant and revoke access privileges to data without the need to write and enter SQL statements into the system.

Moreover, the database management system of the present invention allows a user to select, insert, update and delete rows in a user's tables using an HTML forms-based feature of the database management system. The user does not have to write SQL statements in order to perform these functions. However, an advanced user can use the forms-based feature to generate a SQL statement into a text area in which the user is allowed to modify and execute the SQL statement. The results of select statement functions can be downloaded in a variety of workstation formats.

The present invention, in a further aspect, relates to a database management system for the creation and management of relational data. In one embodiment, the system's database server application is capable of generating commands in HTML and SQL. Upon a request for data from the web browser, the database server application generates a series of statements in SQL in order to query the data dictionary stored within the remote or local storage facilities. A system user can submit a request for data from a web browser that is in communication with the database server application. Upon the reception of this request the database server application automatically generates HTML code that can be utilized by the web browser to create and display a listing of the data that is stored within the database. The returned requested data are displayed to a user as HTML hyperlinks.

The data stored within the data dictionary comprises information regarding an individual user's access rights to stored data. A user may grant or revoke access privileges to those databases to which the user has privileges.

The system data selected from the displayed listing is displayed on the web browser in an interactive HTML format that allows a computer workstation user to edit data information that is displayed by the web browser. The displayed data that is edited by the computer workstation user is summarily submitted to and stored at a remote or local database storage facility. This feature of the invention is accomplished by the database server application of the system generating and executing SQL statements that function to select, insert, update or delete any selected data that is submitted in HTML format to the server via the web browser.

In yet another aspect, the present invention relates to a computerized system for managing relational data over a network. In one embodiment, the computerized system has a computer readable medium and a computer program that is encoded upon the computer readable medium. The computer program is operative when in operative association with a server computer to access, create and manage relational data that is stored within a remote or local database facility over a network.

The computerized system is further operable to generate SQL statements in order to query a remote or local database facility and in response to the query generate in HTML format a listing of items stored within the remote or local database facility. The listing of items that are stored within the remote or local database facility is then displayed at a computer workstation, wherein each item that is accessible in the database is displayed as an HTML hyperlink. Upon the selection of a hyperlink database item by a user the system proceeds to generate SQL statements that will query the remote or local database facility. When the query result data is returned, the data is displayed in an HTML format. The query result data returned by the database server application includes data that is representative of the tables, views and aliases that are accessible in the chosen database.

Moreover, the computerized system is further operable to allow a workstation user to select an item that is displayed as an HTML hyperlink. Upon the selection of a hyperlinked item, the system generates a series of SQL statements in order to query the remote or local database facility corresponding to the item that was chosen. As a result, the system generates and displays at the workstation an interactive HTML form of data from the remote or local database facility corresponding to the item that was chosen.

The interactive HTML form that is displayed to the workstation user provides the workstation user with the option of executing a select, insert, update or delete function query upon the data that is displayed within the interactive HTML form. Accordingly, if the user selects data and executes an insert, update or delete function upon selected data that is stored within the remote or local database facility, the system will generate a series of SQL statements. The SQL query statements for the insert, updating or deletion function are executed by the system upon the selected data that is stored within the remote or local database server and the system displays the result of the function to the user in an HTML form. The user may be given the option at this point to execute a select query function. If the user chooses to perform this function, the system will generate and execute the SQL statements for the selected function and return the results of the selected function to the user in an HTML form.

In a further aspect, the present invention relates to a method for managing a database system for the creation and management of relational data. The method includes the steps of accessing a database that is in communication with the Internet, managing data within the database with a database management application, and storing data that has been updated by the system user within the database. In one embodiment, the step of accessing the database includes accessing the database by interfacing with a computer workstation that is in communication with the Internet.

In a further embodiment of the present invention, the step of accessing the database further includes displaying a list of objects that are stored within the database. Additionally, the step of accessing the database may include the step of restricting a user to accessing data that is related to the objects that the user has access privileges. Accordingly, the user has the capability to view and change object access privileges to objects that the user has been granted access.

In another embodiment, the step of managing data within the database includes the step of generating and displaying an HTML form at a display device, wherein a system user to select object data from the database utilizes the form. The step of managing data within the database includes enabling the system to generate and display an HTML form at a display device, wherein a system user utilizes the form to insert object data into the database.

Additionally, the step of managing data within the database may include the step of generating and displaying an HTML form at a display device, wherein the form is utilized by a system user to edit object data that is stored within the database. The system is also capable of generating and displaying an HTML form at a display device, wherein the form is utilized by a system user to update object data that is stored within the database. The system is additionally capable of generating and displaying an HTML form at the display device wherein the form is utilized to delete object data from the database.

In yet another aspect, the present invention relates to a method for operating a computerized system for managing relational data over a network. In one embodiment, the method includes the steps of remotely or locally accessing a database server with an Internet web browser, utilizing HTML forms to gather data and transmitting form data to the database server, and displaying HTML forms that contain the results of the database query.

The method further includes the step of a user utilizing the HTML form to request a listing of database objects that are stored within a database storage device. In response to the request, the system executes the step of the generating SQL statements that enable the system to query a data dictionary of the database storage device for a listing of stored database objects. As a result, the system displays an HTML form at a user's workstation that contains a listing of database objects that are stored within the database storage device, wherein each accessible database listed is displayed as an HTML hypertext link.

Additionally, the method includes the step of scrolling through the displayed listing of HTML hypertext links of accessible database objects. Subsequently, the system user can request data in regard to a specific object by clicking on the hyperlink listing of the accessible database object. As a result of the user's selection of a database, the system generates a series of SQL statements to query the data dictionary of the database storage device in regard to the objects that are stored within the selected database. When the query function is completed, the system displays an HTML form that contains a listing of the tables, views and aliases that are accessible in the selected database, wherein each listed item is listed and displayed as an HTML hyperlink.

From the hyperlink listing of items, the system user may select a table, view or alias hyperlink. Upon this selection, the system generates SQL statements that query the data dictionary of the database storage device in regard to a selected one of the tables, views or aliases. After the query is completed the system displays an HTML form, wherein the form contains data that is representative of the columns that are defined in a selected table and the data type of the selected item The user may use the HTML form to specify the sort order and search criteria for the selected data. Upon the user's submission of the form to the system, the system returns and displays an HTML form that contains the selected data in the requested format.

In a further embodiment, the method presents the user with an option of editing requested database data to which the user has been granted access. This function is accomplished within the system by the system's generation of SQL statements that query the data dictionary and return data that is selected for an insert, delete or update function. The returned data is displayed by the system in an HTML form, thus allowing for an user to edit data by entering new data or deleting existing data.

The method further includes the step of submitting the HTML form containing the edited data to the system, wherein the system then generates SQL statements based on information contained within the HTML form and submits the SQL to a database engine. Next, the database engine performs the requested editorial function of inserting, deleting or updating the selected data within the database storage device.

The present invention comprises a navigation tool that allows a system user to navigate through the system's database catalogues. In one embodiment a user can view and access lists of database objects for different object owners. However, users are restricted to displaying and accessing only the objects to which they have access privileges. The navigation tool further includes the abilities of enabling a user to search or drill down through data in order to obtain object definitions and to add columns to a data table. Additionally, a user may view and change object privileges on objects to which the user has existing privileges. The system also provides for a user to have seamless transitions to other existing functions that are enabled within the system.

A further embodiment of the present invention provides an interactive HTML form to a user. Using an interactive HTML form that is automatically generated by the system, a user has the ability to manipulate data stored in the database management system. In particular, the system automatically generates HTML forms and presents these forms to a user for selecting, inserting, editing, updating and deleting data therein. The system automatically selects and presents data types to a system user. Additionally, the column names utilized within databases can be displayed in column or alphabetic order.

A user may choose the particular columns to be manipulated by the selecting, inserting, editing, updating and deleting function of the management system. For the selection function, a user can specify the sort order of the requested data. Null data values are handled and processed properly and automatically within the inherent functions of the database management system. Additionally, a user may choose search operation conditional selection commands (e.g., =, <>, >, <, or the like) from a drop down list that is displayed to the system user. A user may clear the forms of data, and also data search results contain navigation back to the interactive HTML form process of the system. The form carries forward selected row values.

The update and delete operational functions contain the ability to present a confirmation page, the confirmation page is displayed if system actions will affect more than one row, and thus a user is presented with the choice of proceeding with or canceling an operation. The system also provides a user with the capability to generate SQL statements from select, edit, insert, update and delete statements that are selected by the user. The utilization of these functions allow for a user to modify and run generated SQL, add, update and delete a saved SQL, and change the table with which the user is working. Consistent database navigation is provided through using standard button bars and additional button bars that are provided to allow a user to easily go to other system functionality's such as the systems database navigator function.

Thus, the present invention provides a system and method for accessing a database management system, which can be utilized to aid in the creation and management of relational data. The database management system of the present invention is compatible to the Internet and can be accessed from the Internet, which allows users to access data at any time from anywhere through a workstation connected to the Internet. Among other things, the present data management system provides a user-friendly access means to data that is stored in the database management system. System users with little or no knowledge of any database management system can access, store and manage data over the Internet by use of a web browser.

Moreover, the present database management system provides a generic platform so that any user can select, input, edit, update and delete data without creating a custom software application on a system for each user. The generic characteristic of the database management system of the present invention precludes the need to create one application per user for the purpose of selecting, editing, inputting, updating and deleting their own data, thus resulting in significant savings in software development costs.

These and other aspects will become apparent from the following description of the various embodiments taken in conjunction with the following drawings, although variations and modifications may be effected without departing from the spirit and scope of the novel concepts of the disclosure.

### BRIEF DESCRIPTION OF THE DRAWINGS

FIG. 1A is a block diagram showing system architecture for a database management system according to one embodiment of the present invention.

FIG. 1B is a flowchart showing database navigator and dynamic HTML form generator functions of the present invention.

FIGS. 2-10 are flowcharts illustrating navigator function program flow according to one embodiment of the present invention.

FIGS. 11-29 are flowcharts illustrating dynamic form generation process and functionality program flows according to one embodiment of the present invention.

FIGS. 30-31 are flowcharts illustrating processes and functions related to the method of handling and processing results of SQL select queries according to one embodiment of the present invention.

FIGS. 32-34 are flowcharts illustrating grant/revoke privilege function of the present invention according to one embodiment of the present invention.

FIG. 35 is a flowchart illustrating a process of adding a column to a table according to one embodiment of the present invention.

FIGS. 36-42 show user interactive HTML forms created on a web page in one embodiment of the invention.

### DETAILED DESCRIPTION OF THE INVENTION

Several embodiments of the invention are now described in detail. The disclosed embodiments are intended to be illustrative only since numerous modifications and variations therein will be apparent to those of ordinary skill in the art. In reference to the drawings, like numbers will indicate like parts continuously throughout the views. As utilized in the description herein and throughout the claims that follow, the meaning of “a,” “an,” and “the” include plural references also, unless the context of use clearly dictates otherwise. Additionally, the meaning of “in” includes “in” and “on” unless the context clearly dictates otherwise as the term is utilized in the description herein and throughout the claims that follow.

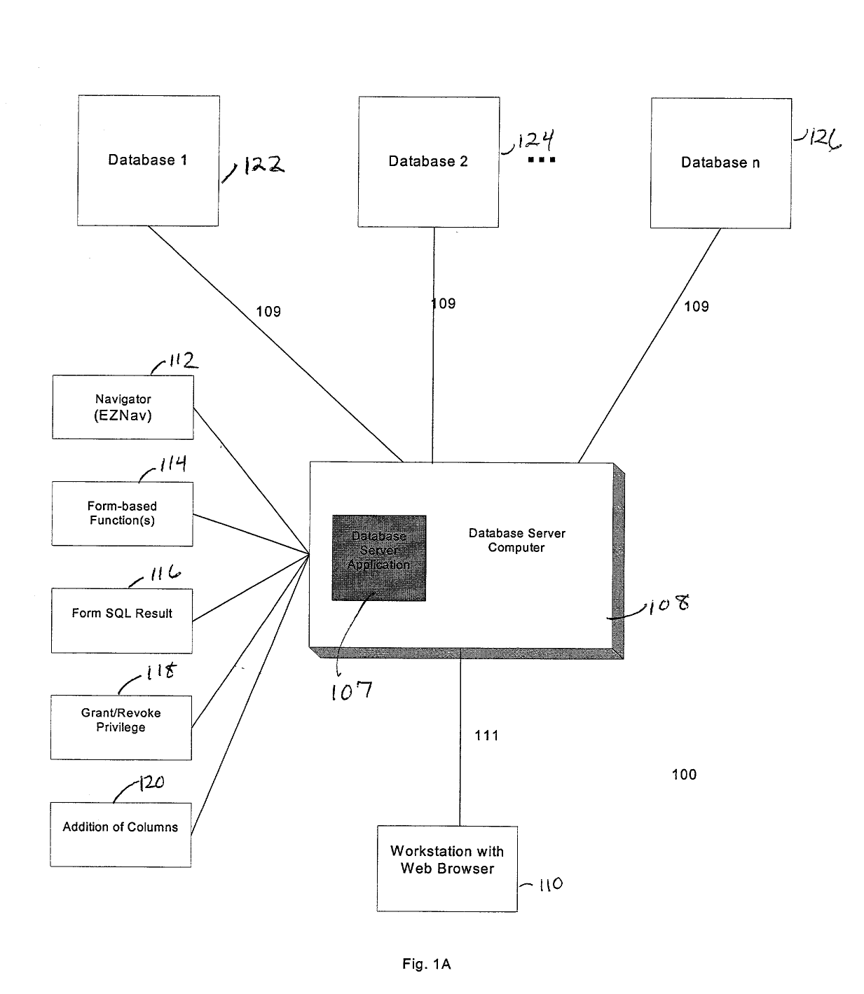

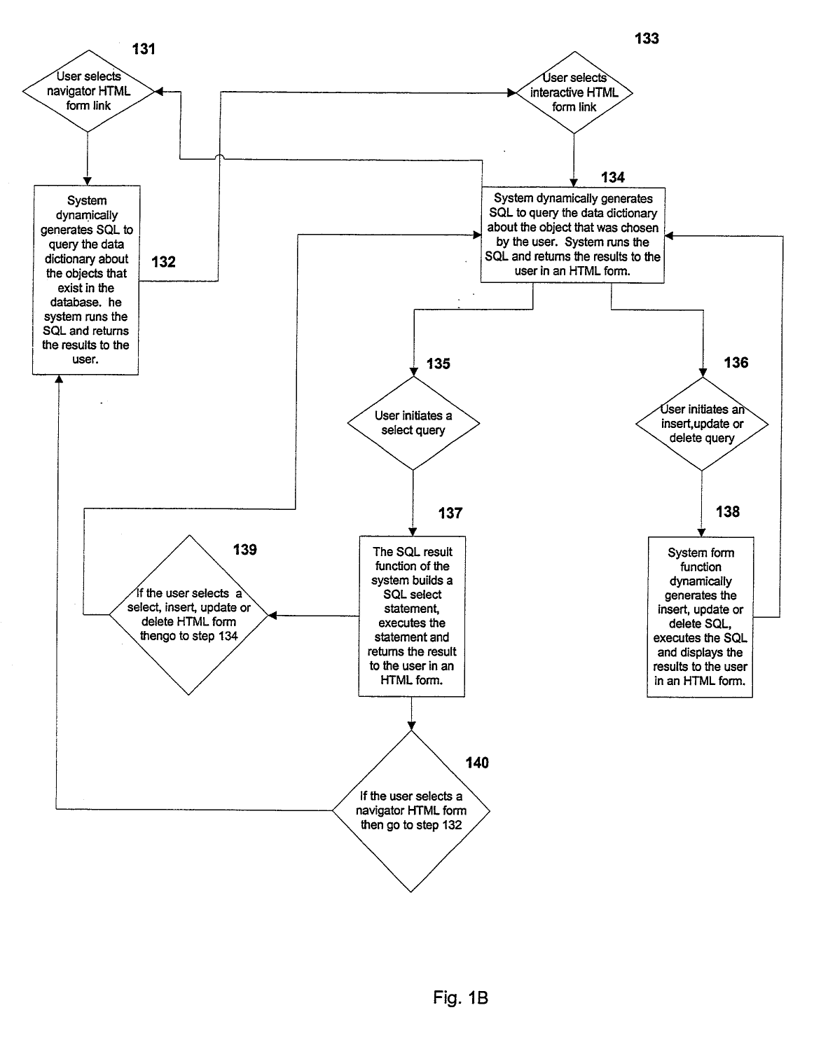

The present invention is initially described in reference to FIGS. 1-11. FIG. 1A is a block diagram illustrating the hardware and software components of a database management system (100) according to one embodiment of the invention. A user of a web browser (110) in communication with a database server computer (108) can access a plurality of databases (122-126), from database 1 to database n, where n is representative of an integer. The web browser (110) generally is a program resident in a computer workstation (also shown as 110). Each database contains data that is stored in a database storage device, such as a memory. The memory can be a memory device associated with a computer or a separate device.

The database management system of the present invention allows for a user to access a plurality of databases and execute a plurality of functions via a database server application (107) that is executed in the database server computer (108). These functions include a database navigation function (112), an interactive HTML form-based function (114), a SQL result process (116), a granting/revoking privilege function (118) and a function for the addition of columns to a database (120).

In one embodiment, the database management system includes a computer program that is encoded on a computer readable medium to implement these and other functions. The computer readable medium can be memory type devices such as hard drives, recordable type media such as floppy disks and CD-ROMs and transmission type media such as digital and analog communication links. The computer program can be implemented with the computer workstation (110) or the database server (108). When it is implemented, the computer program is in operative association with the database server computer (108) and is operative to perform these functions to access, create, edit and manage relational data stored in databases 1 to database n (122-126). The database server application (107) is such a computer program.

FIG. 1B is a flowchart illustrating database navigator and dynamic HTML form generator functions of the present invention that are allowable at the workstation (110). If a user selects the navigator function (112) at step 131 then at step 132 the database server application (107) dynamically generates SQL statements to query the data dictionary in regard to the objects that are currently residing in the database storage (122-126). The database server application (107) will execute the SQL statements and return the result to the user in an HTML viewable format at the workstation web browser (110).

At step 133, the user can choose to utilize the interactive form function (114). Upon selection of the interactive form function (114) at step 133, the database server application (107), at step 134, dynamically generates SQL statements to query the database dictionary in regard to the object that was chosen by the user. Next the database server application (107) executes the SQL statements and accordingly returns an interactive HTML form to the user at the workstation (110). The form presented to the user gives the user the option of selecting data within the database at step 135 or inserting, updating or deleting data that the user has requested at step 136.

If the user chooses to initiate and run a select query at step 135, at step 137 the database server application's (107) SQL Result function (116) dynamically builds a SQL select statement. The database server application (107) executes the SQL statements and returns the results to the user at the workstation web browser (110). At this point, the user may choose at step 139 to initiate and execute, via the workstation web browser (110), a select, insert, update or delete data function or return to a database navigation form at step 140.

Alternatively, if the user chooses to initiate and execute either an insert, update or delete query function at step 136, the database server application (107) will dynamically generate and execute SQL statements in respect to the selected insert, update or delete function at step 138. Next, the database server application (107) executes the SQL statement and the results of the selected function are displayed to the user at the workstation web browser (110).

Referring to FIG. 1A, the database server computer (108) and the computer workstation with a web browser (110) that is in communication with the database server computer (108) are coupled via a communication link (111). The database storage facilities (122-126) are in communication with the database server computer (108) via a communication link(s) (109). The database server computer (108) executes the database server application (107) in the form of a computer program that is encoded on a computer readable medium (not shown). The computer program is operative when in operative association with the database server computer (108) and being capable of accessing, creating and managing relational data that is stored within the database storage facility (122) via the communication link (109).

The computer program is further operable to generate SQL statements in order to query any and at least one of the database storage facilities (122-126). As an example, we assume a query is made to the database storage facility (122). As a result of the query, the program generates an HTML listing of items stored in the database storage facility (122). This list is transmitted via the communication link (111) to and subsequently displayed at the work station web browser (110). Each item that is accessible in the database to a user is displayed to the user as an HTML hyperlink at the workstation web browser (110). The user selects a desired hyperlink database item by clicking on the listed item at the web browser (110) with an input device, such as a mouse (not shown). Subsequently the program generates an SQL statement to query the remote database facility, wherein the resulting query data is returned and displayed to the user in an HTML form at the workstation web browser (110).

In a further embodiment, query result data returned to the user comprises a listing of the tables, views and aliases in the chosen database to which the user has access. The user selects a listed item that is displayed in an HTML hyperlink format. Upon the selection of the hyperlinked item, the database server (108) executes the program to generate SQL statements to query the remote database facility in regard to the item that was chosen. Furthermore, the program generates and transmits to the workstation web browser (110) an interactive HTML form that contains database data in regard to the item that was selected by the user.

The interactive HTML form that is presented to the user at the workstation web browser (110) contains a series of interactive function options that the workstation user has the option of executing. These functions include the options of performing a select, insert, update or delete function query upon the data that is displayed within the interactive HTML form. If the user executes an insert, update or delete function upon selected data that is stored within the remote database facility, the program generates the SQL command statements for the appropriate insert, updating or deletion function. Summarily, the database server computer (108) executes the SQL statements upon the selected data that is stored within the database storage facility (122) and displays the result of the function to the user in HTML format at the workstation web browser (110).

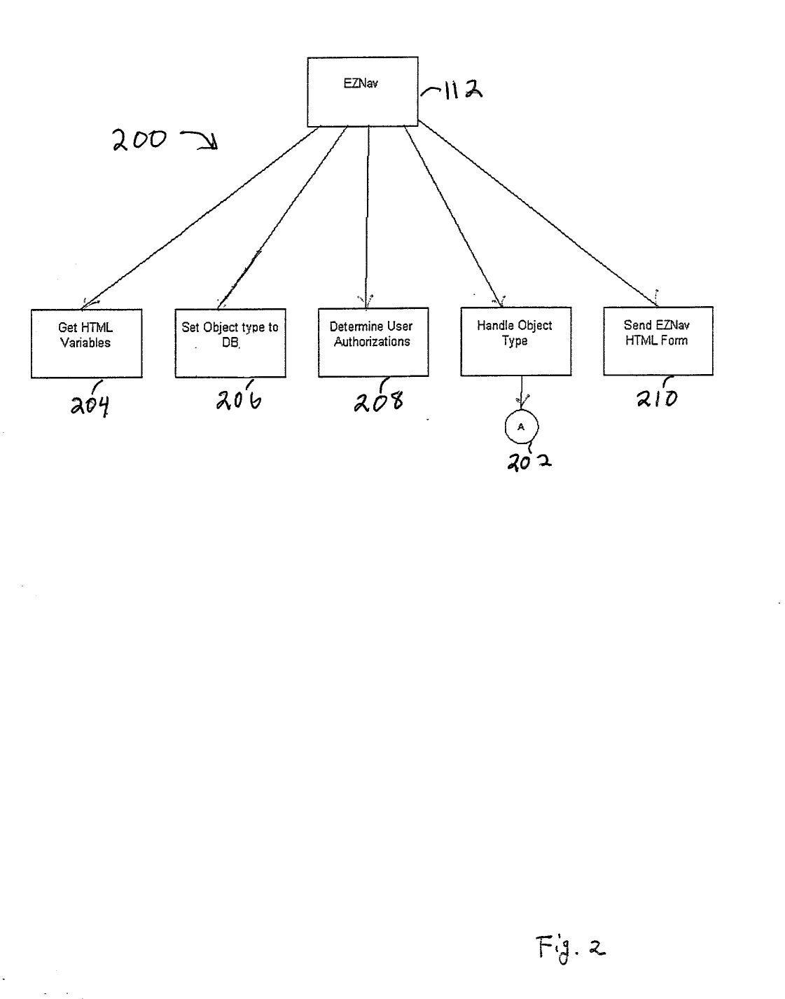

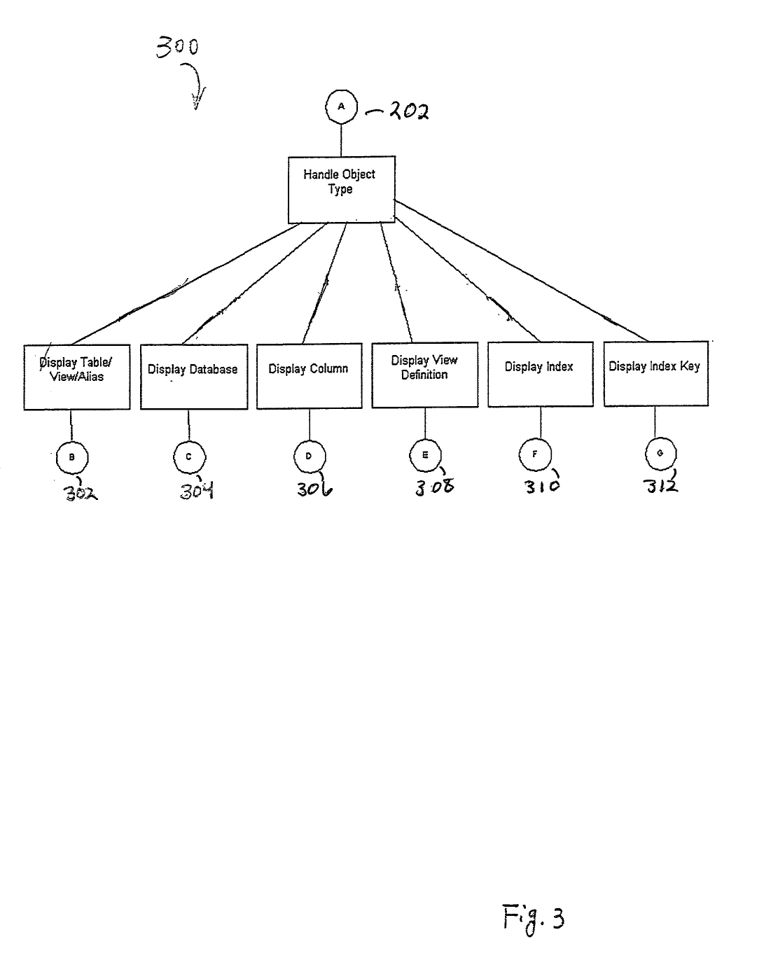

FIGS. 2-10 further illustrates the navigator function program flow of the present invention. As shown in FIG. 2, the navigator feature, identified as “EZNav” (112), comprises multiple internal systematic processes and user interactive functions. Upon initiation of the navigator function (112), the database server application (107) generates a series of HTML variables at step 204. The database server application (107) determines the object type, if the object type is blank then the object type is set to the database at step 206. At step 208 the database server application (107) determines the user's authorizations in regard to stored database objects. The accumulated data is compiled in an HTML format and delivered to the user at step 210. These steps, as other steps described in the specification, can be performed in parallel or in sequence unless it is clearly indicated otherwise. Step 202 is an interactive function wherein the workstation web browser (110) displays the requested object type and can be further pursued. As shown in FIG. 3, the step of 202 may be continued to allow the database server computer (108) transmitting for display to the web browser (110) various objects such as tables, aliases or views at step 302, databases at step 304, columns at step 306, view definitions at step 308, indexes at step 310 and index keys at step 312, which are further discussed below.

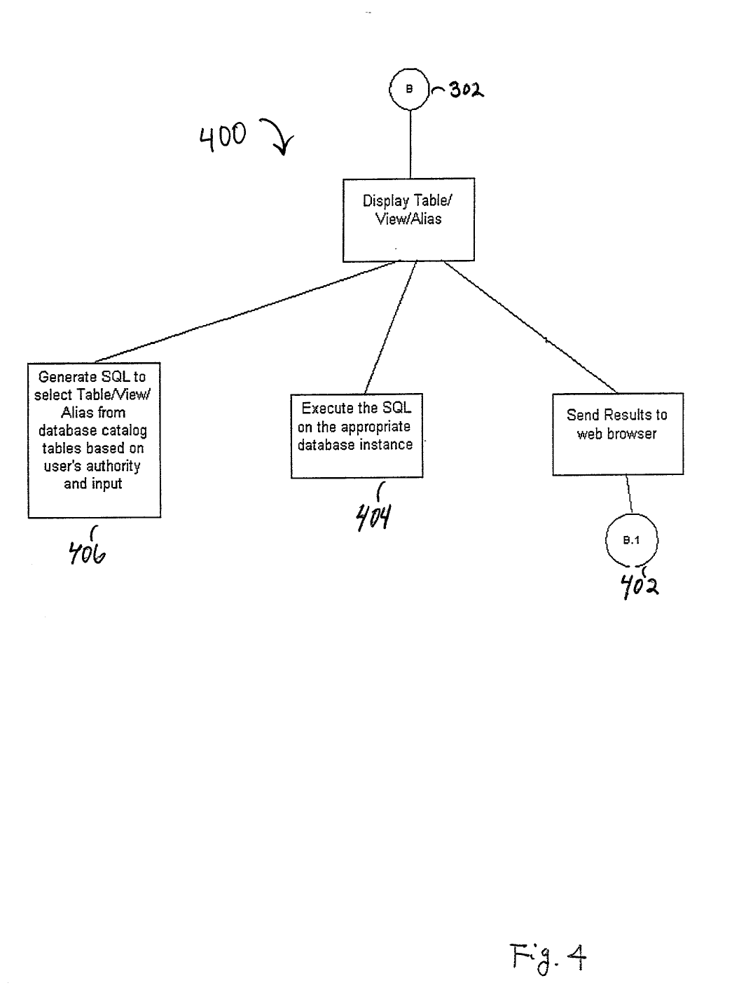

For example, a process 400 related to the displaying of tables, aliases or views of step 302 is show in FIG. 4. If at step 302, the user requests table, alias or view is displayed to the user, at step 406 the database server application (107) generates SQL statements to query the data dictionary of the database storage facilities (122-126) to select the requested table, alias or view from database catalog tables based on the authority of the user. At step 404, the database server application (107) executes the SQL statements on the appropriate database instance, and summarily at step 402, the results are transmitted to the user and displayed at the workstation web browser (110).

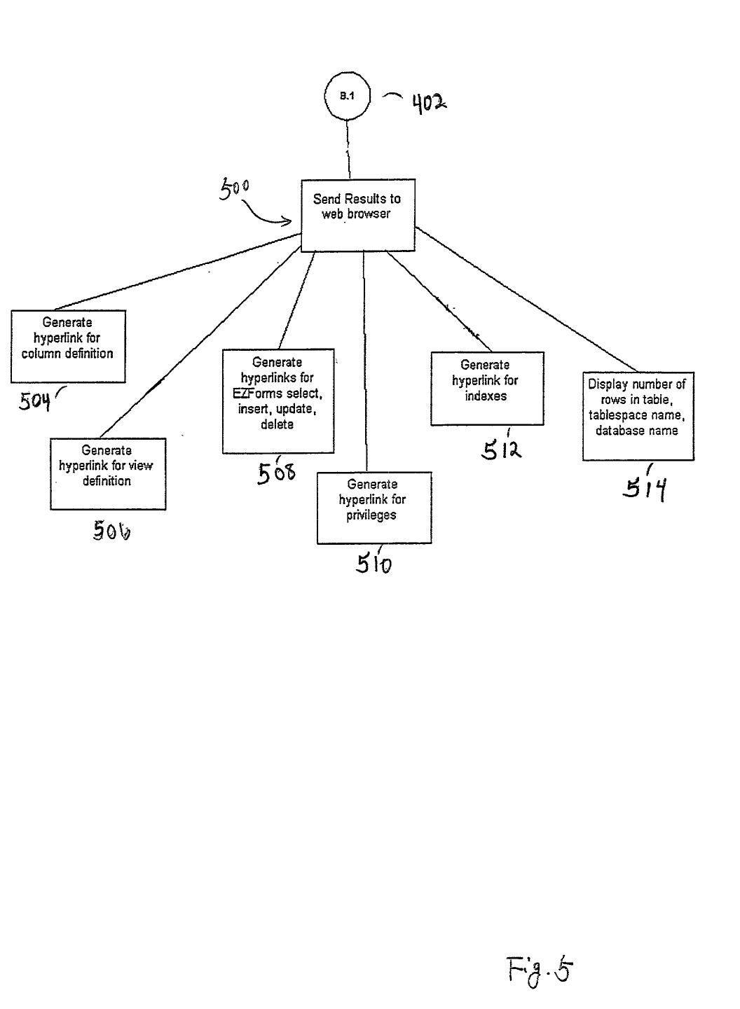

A process 500 that is related to transmitting the results to the web browser of step 402 is shown in FIG. 5. At step 504 the database server application (107) generates a hyperlink for the column definition. If the object type is a view, then the database server application (107) generates a hyperlink for the view definition at step 506. Next, the database server application (107) generates hyperlinks for the database management system's editorial form function at step 508. Step 510 is dedicated to the generation of hyperlinks in regard to user privileges. If the requested object type is a table, then at step 512, the database server application (107) generates hyperlinks for the indexes referenced within the database. Finally, at step 514, the database server (108) will transmit data that lists the number of rows within a table, the table-space name and the database name to the workstation web browser (110), where the data will be displayed to the user.

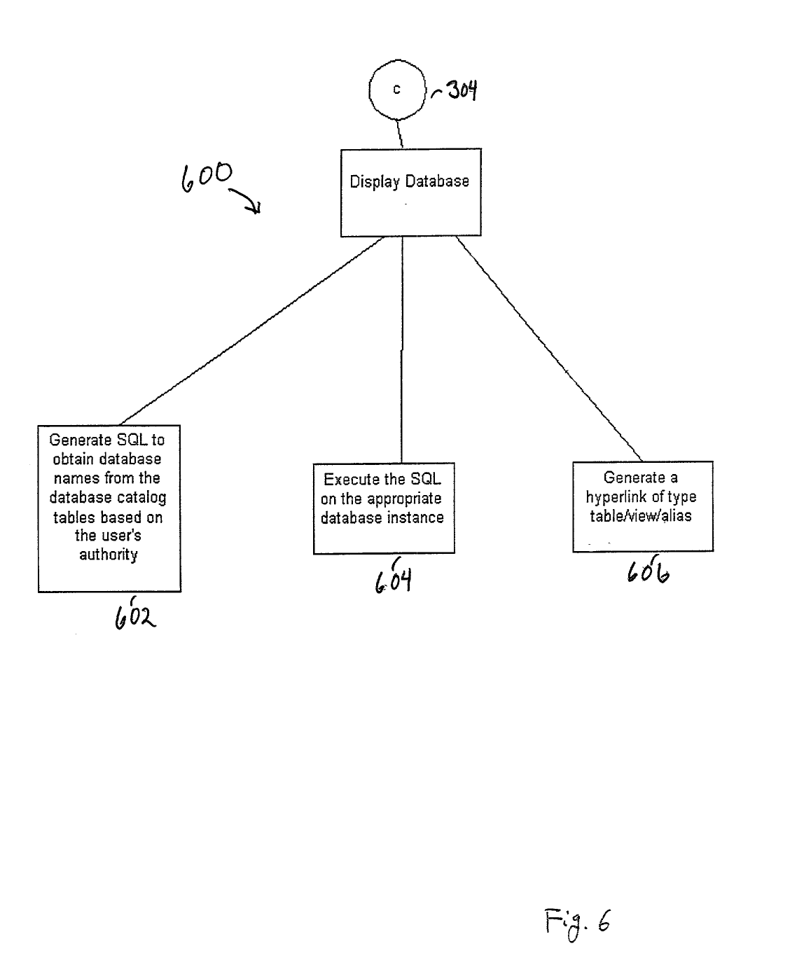

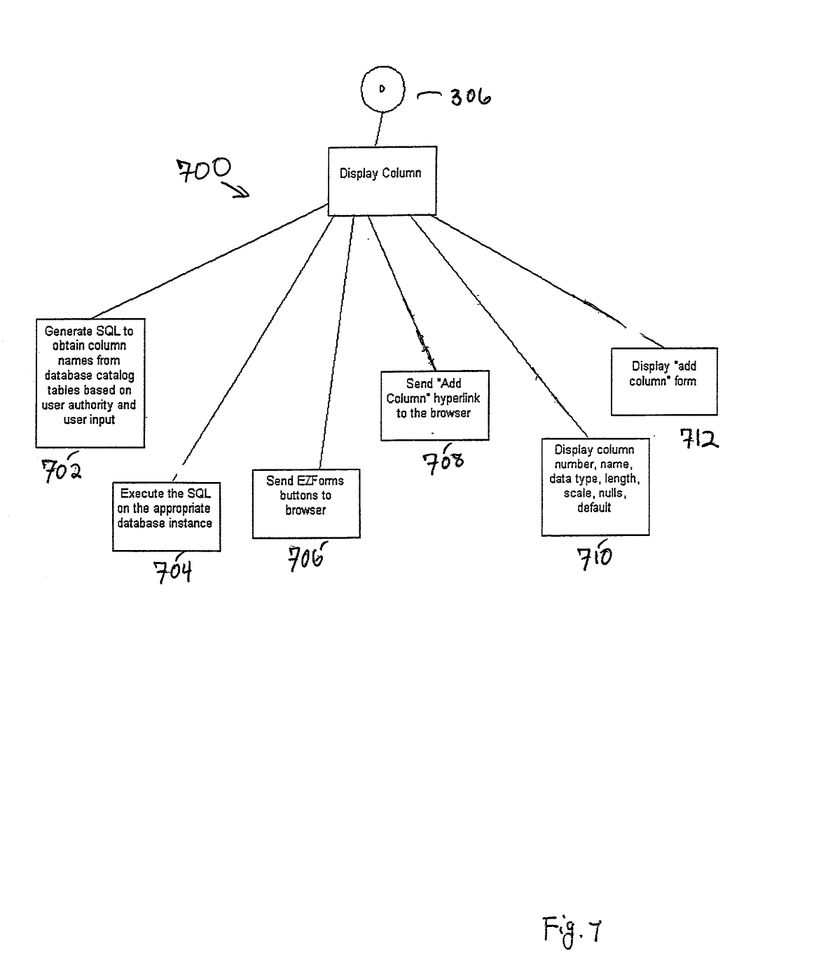

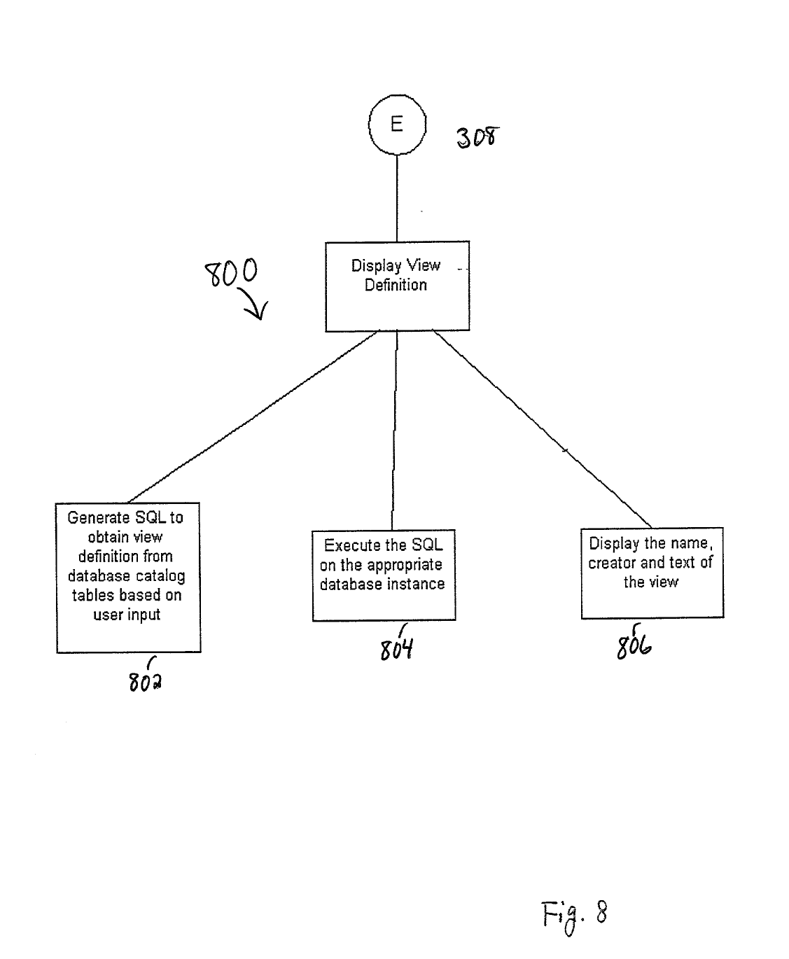

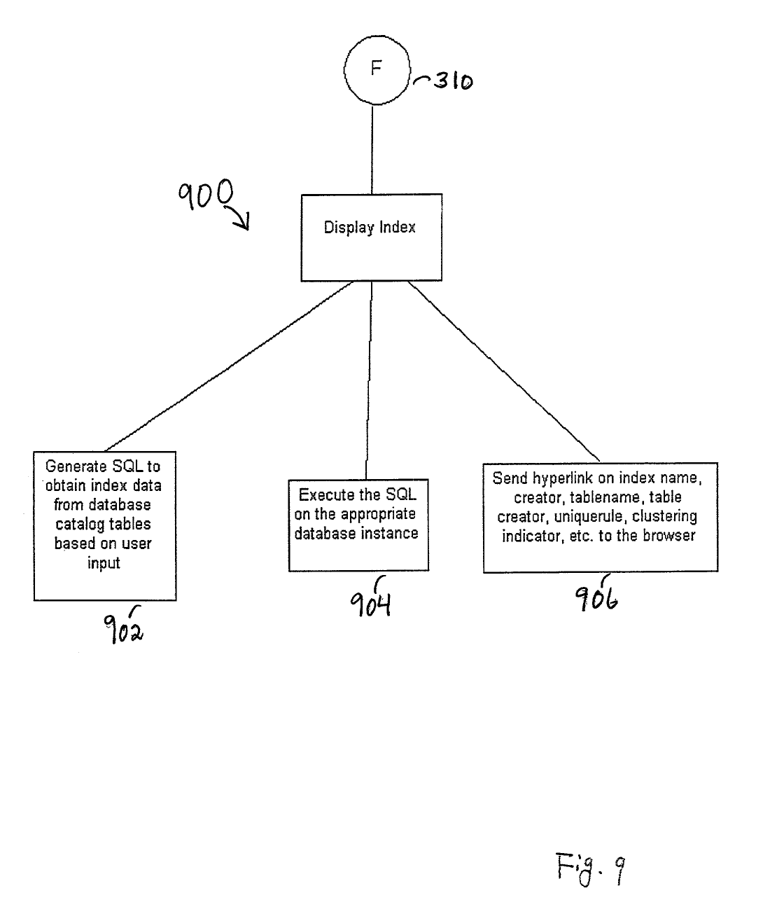

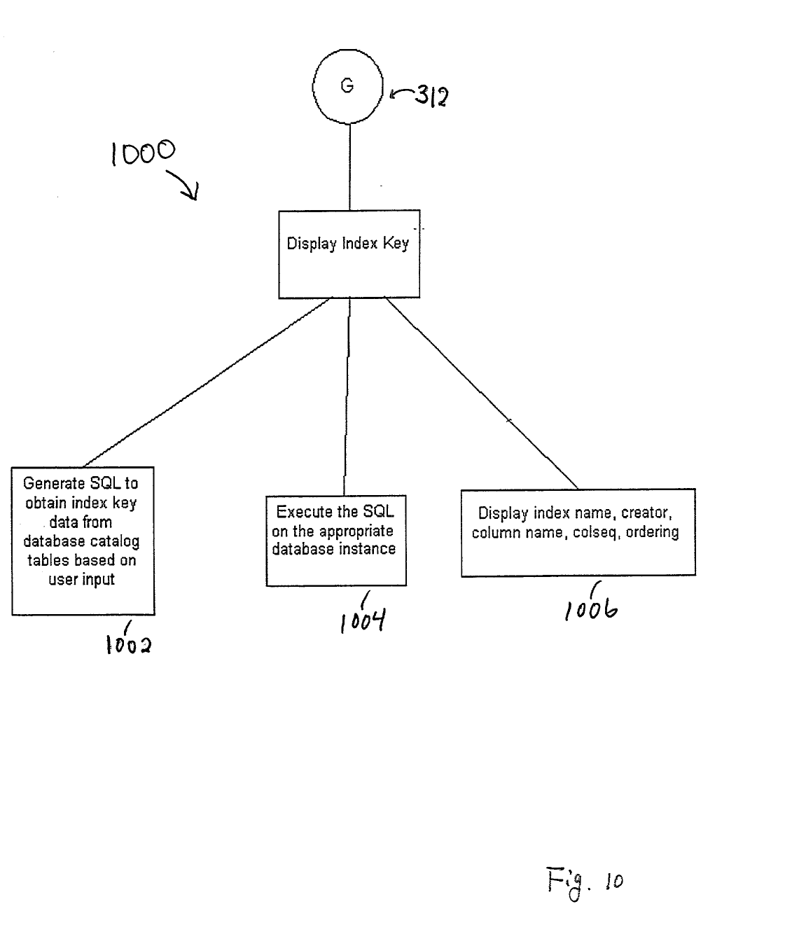

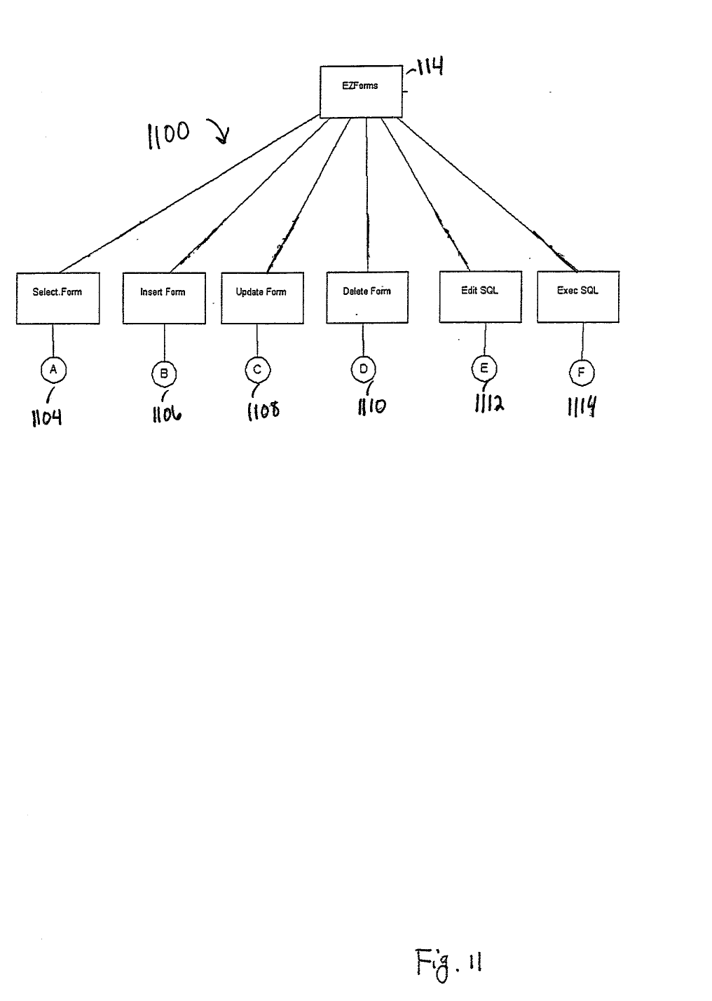

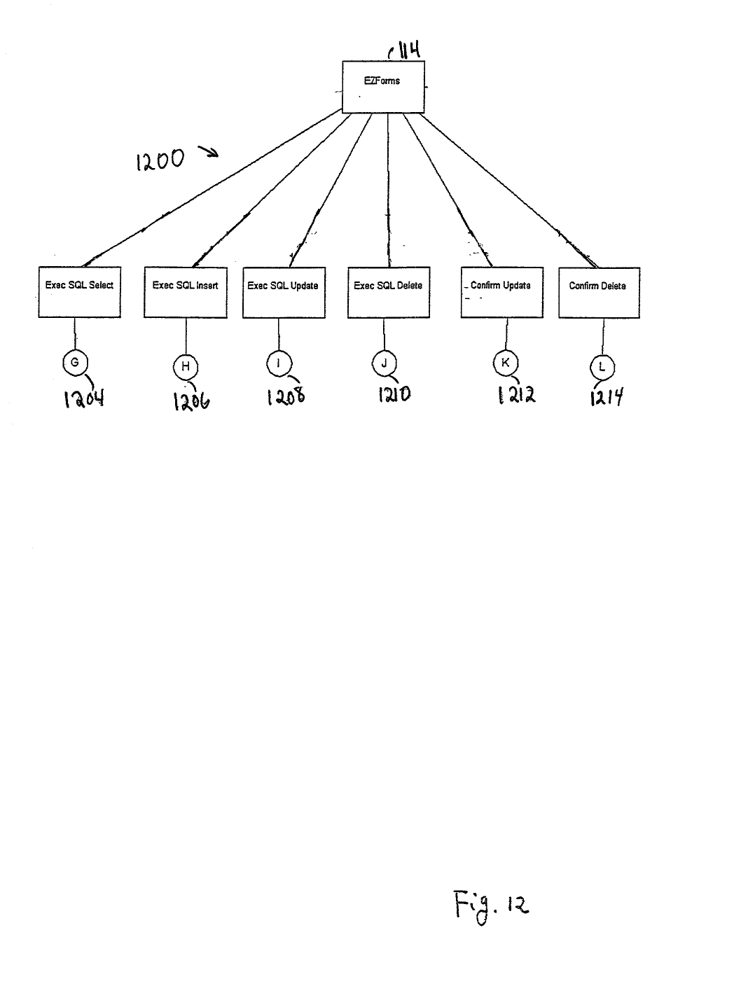

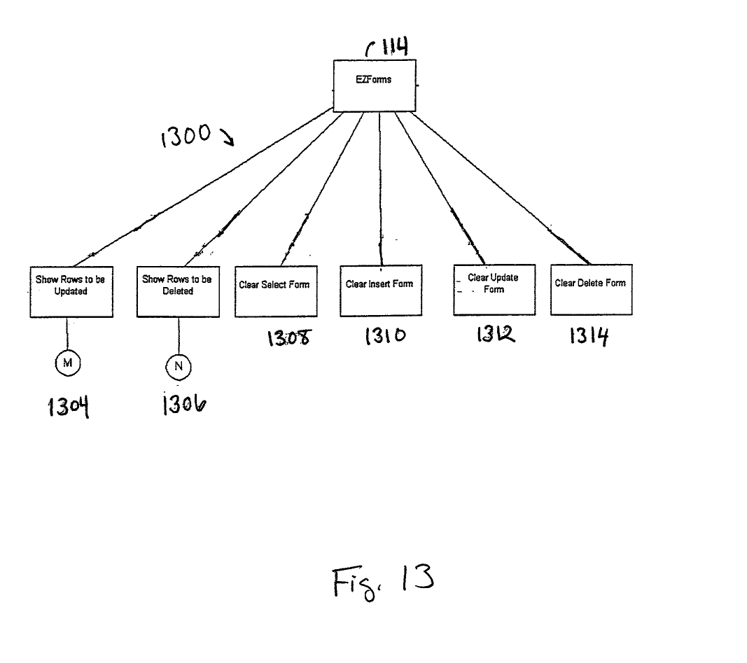

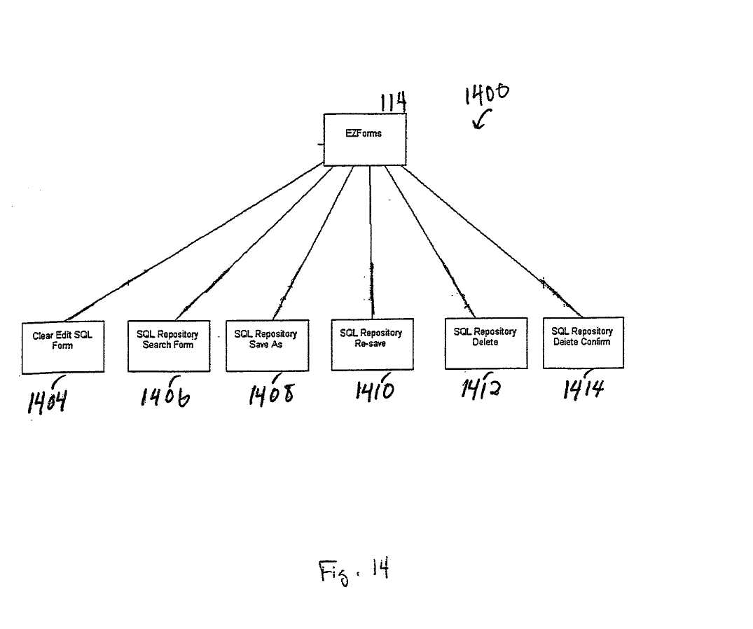

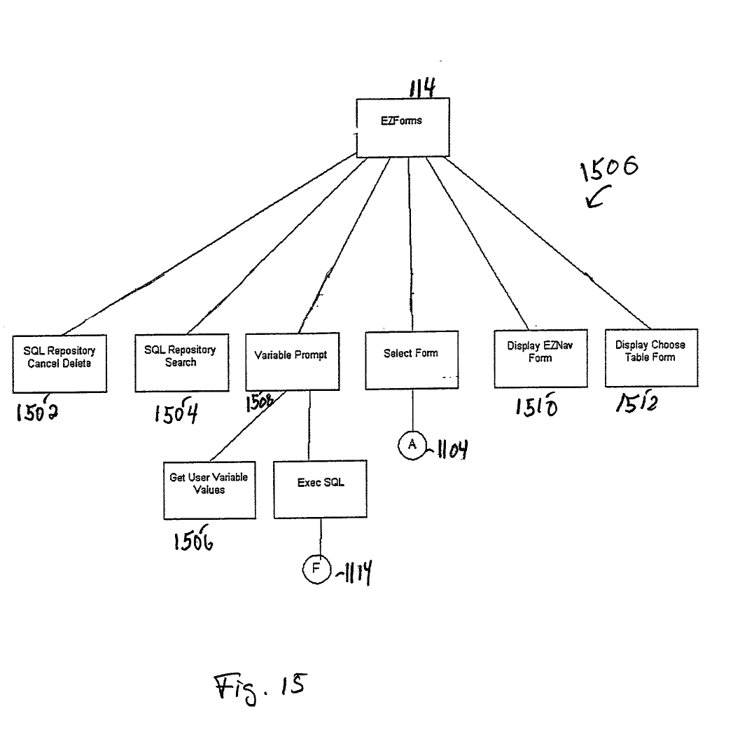

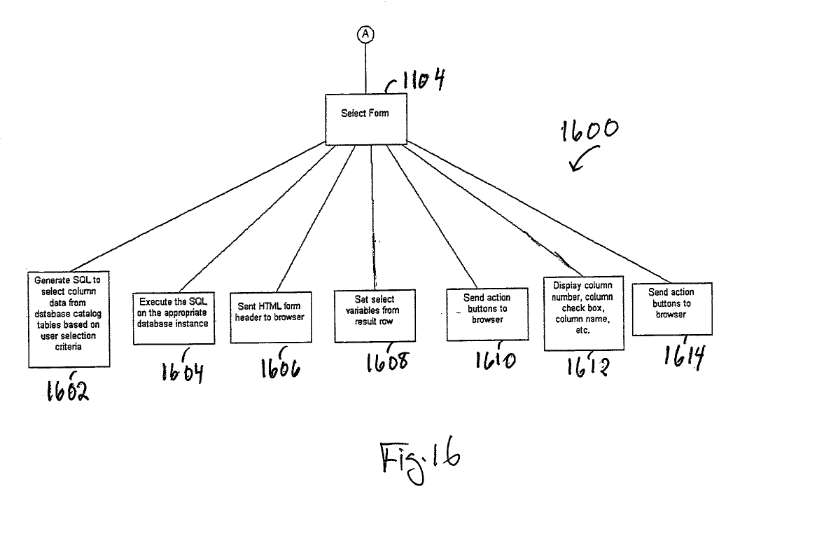

The process 600, which is related to displaying database data of step 304, is shown in FIG. 6. At step 602 the database server application (107) generates SQL statements in order to query the database dictionary of the remote databases (122-126) in order to obtain database names from the database catalog tables based upon the user's authority. The generated SQL statements are executed at step 604. Thereafter, the database server application (107) generates and the application server (108) forwards to the web browser (110) a hyperlink of the type of data (e.g. table, view or alias) at step 606.

A process 700 related to the display column function of step 306, as shown in FIG. 3, is illustrated in FIG. 7. At step 702, the database server application (107) generates SQL statements in order to obtain column names from a database catalog table, the query being based upon the user's request and authority to access the information. The SQL statements are executed at step 704 upon the appropriate database instance. The database server application (107) generates code for HTML “buttons” or icons and transmits the code to a web browser at step 706, the buttons providing a link between the system's navigation feature and the interactive forms-based feature, identified as “EZForms”. Next, at step 708, the database server application (107) determines if the object type is a table, and if so, if the user has the authorization to alter the contents of the table. If the answer is in the affirmative, then the database server application (107) generates and the database server (108) transmits an “add column” hyperlink to the web browser. Concurrently, at step 712, if the database server application (107) determines the user has the authorization to alter a table an “add column form” is displayed. At step 710, for each row of returned requested data the database server transmits to and displays at the workstation the column number, name, data type, length, scale, nulls and default for the column data.

FIG. 8 illustrates a process 800 related to the display view definition of step 308, where the requested object type is a view definition. Upon a request for view definition data, at step 802, the database server application (107) generates SQL statements to query the database in order to obtain view definition data from database catalog tables. The database server application (107) then executes the SQL statements upon the appropriate database instance at step 804 and the name, creator and text of the view are displayed at the web browser (110) at step 806.

FIGS. 9 and 10 illustrate processes 900 and 1000 related to the displaying of index and index key information of steps 310, 312, respectively. At step 902, when a display index request is received the database server application (107) generates SQL statements to obtain index data from the database catalog tables. The statements are executed at step 904. The results of the search are transmitted as HTML hyperlinks to the web browser at step 906, such hyperlinks including the index name, creator, table name, table creator, unique rule, clustering indicator. Similarly, a request for index key data causes the database server application (107) to generate SQL statements to obtain index key information from the database catalog at step 1002. As previously described, the database server application (107) executes the SQL statements at step 1004 and returns the search results at step 1006. The search results being displayed at the web browser including the index name, creator, column name, column sequence and ordering.

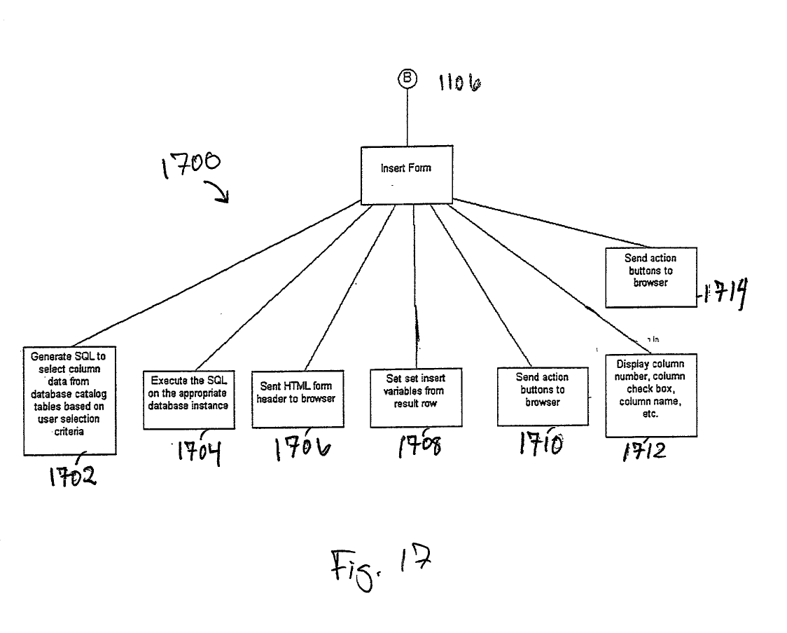

FIGS. 11-15 illustrate the automatic data management HTML form-based function (114), or “EZForms”, of the present invention. FIGS. 16-29 present the internal processes that are affiliated with each function of the HTML form-based function (114) of the present invention, respectively. The form-based function in particular allows a user to manipulate data that is stored within the database storage facilities (122-126). Upon entering the form-based management function a user may proceed with a multiple series of steps or processes. If the function that is requested is the selection of a form, for example, then the select form function at step 1104 is initiated. Similarly, a user may insert data within a form at step 1106. If the function is to update the form or cancel an update then step 1108 is initiated. When the requested function is delete or cancel delete then step 1110 is implemented. EZForms (114) can provide other functions.

FIG. 16 relates to a process 1600 corresponding to the select form function of step 1104. Upon the initiation of the select form function of step 1104, at step 1602 the database server application (107) generates a SQL statement to select column data from a database catalogue table based upon user submitted selection criteria. Summarily, at step 1604, the SQL statement is executed upon the appropriate database. At step 1606 the HTML form header is transmitted to the workstation web browser (110). If the function previous to the select form step 1104 is the SQL result function (116), then the database server application (107) sets the select variables from the resultant row at step 1608. If the previously performed function is not a SQL result function then the database server application (107) sends HTML function buttons to the workstation browser (110) at step 1610, the buttons thus allowing the user to interact with the data. Data is also transmitted to the web browser (110) for each column contained within a table at step 1612 (e.g., data including the display column number, column check box, column and column name). Finally, at step 1614, a final set of interactive HTML function buttons is sent to the web browser (110) for display to the user.

The insert form process of step 1106, update form process of step 1108 and the delete form process of step 1110 include steps that are substantially identical to the steps that are implemented within the select form function. FIG. 17 illustrates a process 1700 related to the insert form of step 1106. The insert form function is initiated at step 1106. Thereinafter, the database server application (107) generates a SQL statement to select column data from a database catalogue table based upon user submitted selection criteria at step 1702. At step 1704, the SQL statement is executed upon the appropriate database.

The HTML form header is transmitted to the workstation web browser (110) at step 1706. If the function previous to the select form step 1106 is the SQL result function (116), then the database server application (107) will set the select variables from the resultant row at step 1708. If the previously performed function was not a SQL result function then the database server application (107) sends HTML function buttons to the workstation browser (110) at step 1710, the buttons thus allowing the user to interact with the data. Data is also transmitted to the web browser (110) for each column contained within a table at step 1712 (e.g., data including the display column number, column check box, column and column name). At step 1714, a final set of interactive HTML function buttons is sent to the web browser (110) for display to the user.

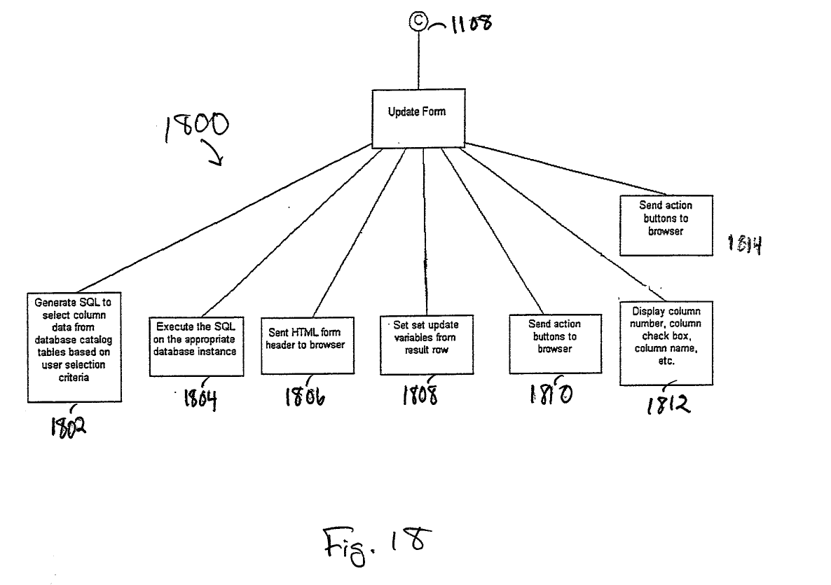

FIG. 18 is a flowchart illustrating a process 1800 related to the update form function of step 1108. When the select form function of step 1108 is activated, the database server application (107) generates a SQL statement to select column data from a database catalogue table based upon user submitted selection criteria at step 1802. Summarily, at step 1804, the SQL statement is executed upon the appropriate database. At step 1806 the HTML form header is transmitted to the workstation web browser (110). If the function previous to the select form step 1108 is the SQL result function (116), then the database server application (107) sets the select variables from the resultant row at step 1808. If the previously performed function is not a SQL result function then the database server application (107) sends HTML function buttons to the workstation browser (110) at step 1810, the buttons thus allowing the user to interact with the data. Data is also transmitted to the web browser (110) for each column contained within a table at step 1812 (e.g., data including the display column number, column check box, column and column name). Lastly, at step 1814, a final set of interactive HTML function buttons is sent to the web browser (110) for display to the user.

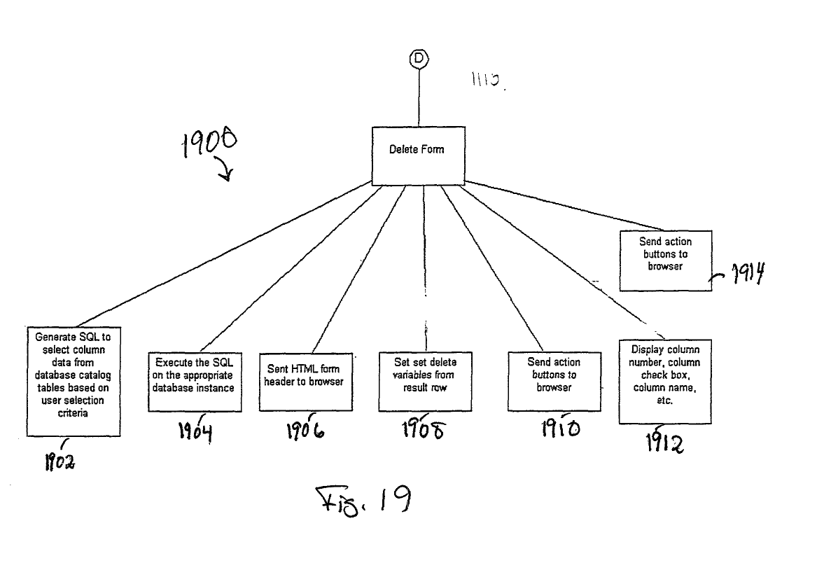

A process 1900 related to the delete form function of step 1110 is illustrated in a flowchart in FIG. 19. The initiation of the select form function of step 1110 causes the database server application to (107) generates a SQL statement to select column data from a database catalogue table based upon user submitted selection criteria at step 1902. Summarily, at step 1904, the SQL statement is executed upon the appropriate database. At step 1906 the HTML form header is transmitted to the workstation web browser (110). If the function previous to the select form step 1110 is the SQL result function (116), then the database server application (107) sets the select variables from the resultant row at step 1908. If the previously performed function is not a SQL result function then the database server application (107) sends HTML function buttons to the workstation browser (110) at step 1910, the buttons thus allowing the user to interact with the data. Data is transmitted to the web browser (110) for each column contained within a table at step 1912 (e.g., data including the display column number, column check box, column and column name). Finally, at step 1914, a final set of interactive HTML function buttons is sent to the web browser (110) for display to the user.

SQL statements can be edited or executed within the form-based functionality of the present invention. If the user desired function is to edit an SQL statement, then step 1112 is implemented. Accordingly, a user may execute SQL statements in regard to the functions of executing SQL statements at step 1114, executing SQL selection statements at step 1204, executing SQL insert statements at step 1206, executing SQL updating statements at step 1208 and executing SQL delete statements at step 1210.

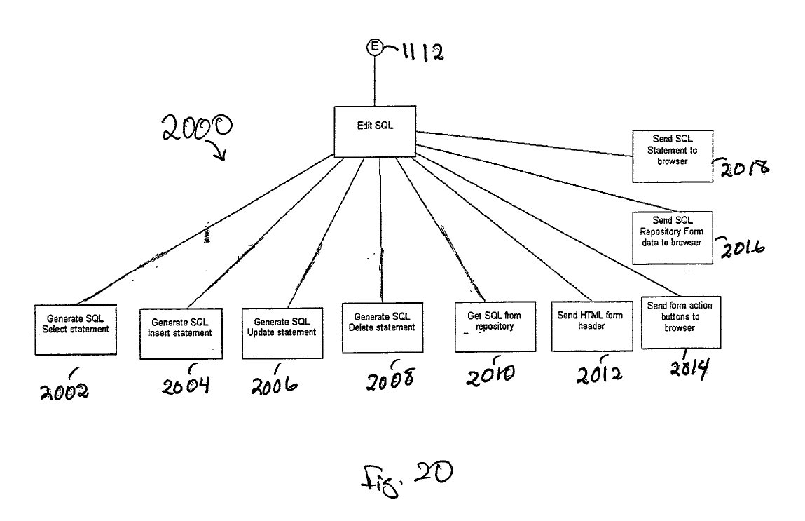

As mentioned above, the present invention has the capability to allow a user to edit various SQL statements that are utilized within the database management system (100). The edit SQL function is initiated at step 1112 of FIG. 11. In reference now to FIG. 20, the editorial function that is accessed is determined by the previously performed database management application (107) function. If the previous function is a select form function of step 1104, then the database server application generates a SQL select statement at step 2002. If the previous function is an insert form function of step 1106, then the database server application (107) generates a SQL insert statement at step 2004. In the instance that the previously preformed function is the update form function of step 1108, then the database server application (107) generates a SQL update statement at step 2006. If the previously performed function is a delete form function of step 1110, then the database server application (107) generates a SQL delete statement at step 2008. If the previous preformed function activates the SQL repository form function, then the database server application (107) retrieves the SQL statement from a repository (not shown) at step 2010. Then, at steps 2012 and 2014, the database server application (107) transmits an HTML form header and interactive HTML buttons to the workstation web browser (110), respectively. Lastly, if the any of the functions of steps 2002-2008 is activated the database server application (107) sends the appropriate retrieved SQL statement to the web browser (110) at step 2018. Accordingly, If the function of step 2010 is initiated then the database server application (107) transmits the retrieved SQL repository form data to the web browser (110).

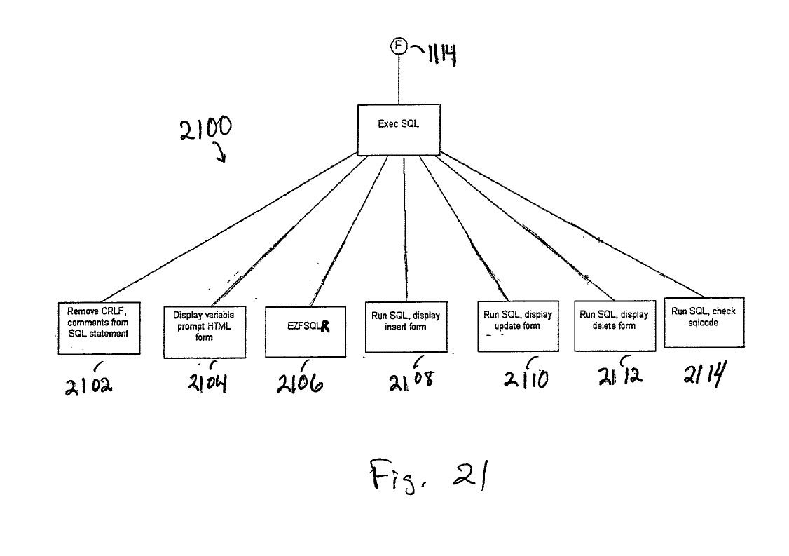

FIG. 21 is a flowchart illustrating a process 2100 related to the SQL execution function of step 1114. When the SQL execution function of step 1114 is initiated, the database server application (107), at step 2102, removes the carriage return followed by line feed (CRLF) comments from the SQL statement. Next, depending on the user requested function the database server application (107) executes the corresponding SQL statement. When the SQL statement contains the “&” variable prompt, a variable prompt HTML form is generated by the database server application (107) and transmitted to the web browser (110) at step 2104. If a SQL statement type chosen by the user is select then the SQL form function, identified as “EZFSQLR”, is initiated at step 2106. If the chosen SQL statement type is either insert, update or delete, then the database server application (107) runs the SQL and transmits to the web browser (110) the display form for the chosen function at steps 2108, 2110 or 2112, respectively. If none of the previous options is selected, the database server application runs the selected SQL statement and checks the SQL code at step 2114.

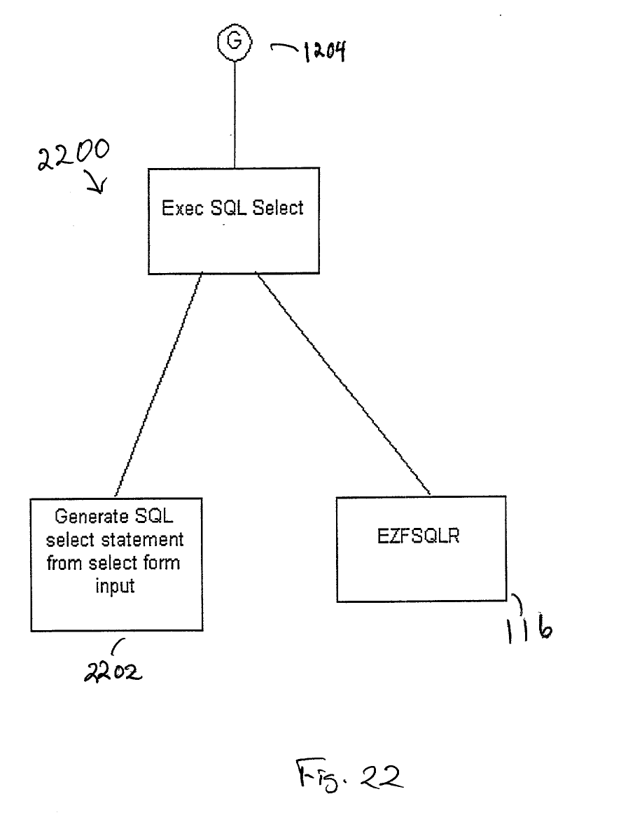

FIG. 22 illustrates a process 2200 related to the SQL select execution function of step 1204. Upon initiation of the SQL select function, the database server application (107) generates at step 2202 a SQL select statement from the select form input. Upon completion of this step the database server application initiates the SQL result form function (116).

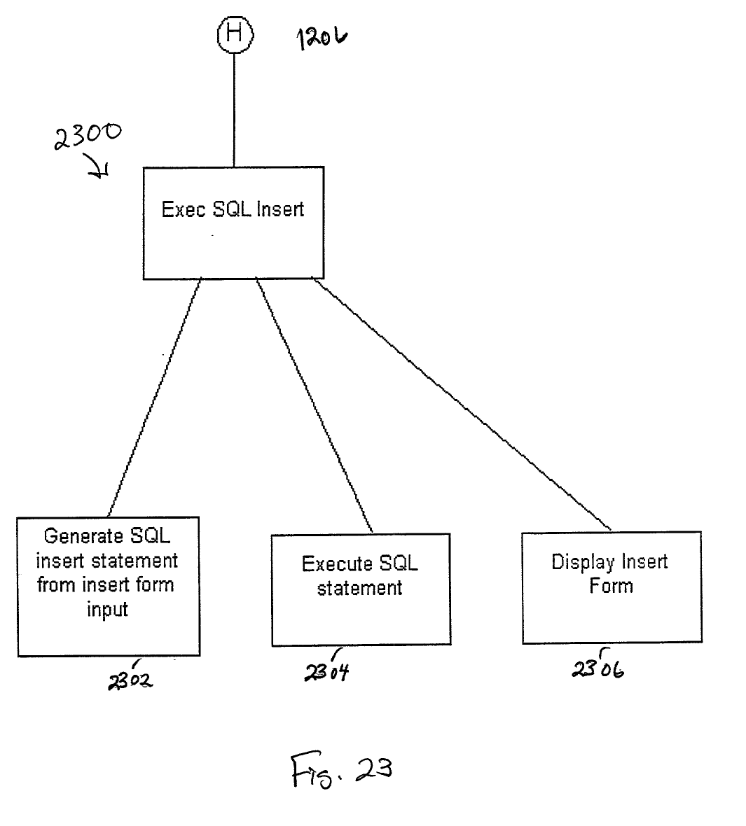

FIG. 23 is a flowchart illustrating a process 2300 related to the SQL insert execution function of step 1206. At step 2302, the database server application (107) generates a SQL insert statement from insert form data input. Next, at step 2304 the database server application executes the SQL statement. Lastly, at step 2306, the database server application (107) displays an insert form to the user at the web browser (110).

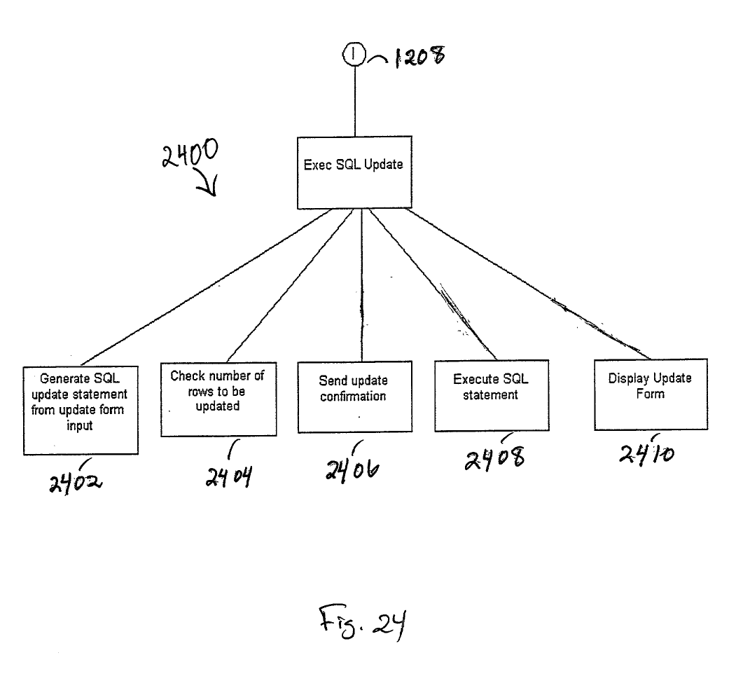

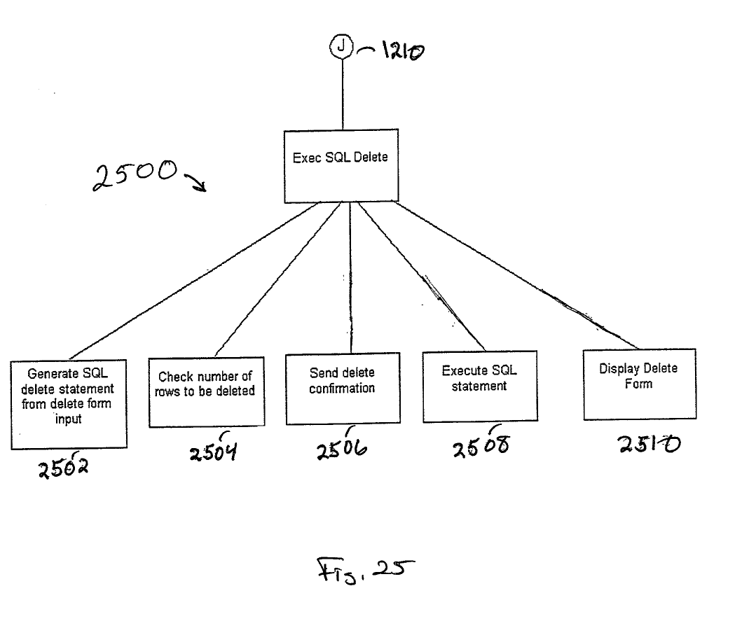

Processes 2400 and 2500 related to the SQL update and delete execution functions are presented in FIGS. 24 and 25, respectively. In regard to the SQL update execution function of step 1208, the database server application (107) generates of a SQL update statement from the update form input data at step 2402. Next, at step 2404 the database server application (107) checks the number of rows to be updated. If the database server application (107) determines the number of rows to be updated to be greater than 1, then an update confirmation form is transmitted to the user at step 2406 and displayed at the web browser (110) at step 2410. If the number of rows to updated is determined to be less than or equal to 1, then the database server application (107) executes the SQL statement at step 2408 and transmits an update form to the web browser at step 2410.

Referring now to FIG. 25, in regard to the SQL delete execution function of step 1210, the database server application (107) generates a SQL update statement from the delete form input data at step 2502. Next, at step 2504 the database server application (107) checks the number of rows to be deleted. If the database server application (107) determines the number of rows to be deleted to be greater than 1, then a delete confirmation form is transmitted to the user at step 2506 and displayed at the web browser (110) at step 2510. If the number of rows to deleted is determined to be less than or equal to 1, then the database server application (107) executes the SQL statement at step 2508 and transmits a delete form to the web browser at step 2510.

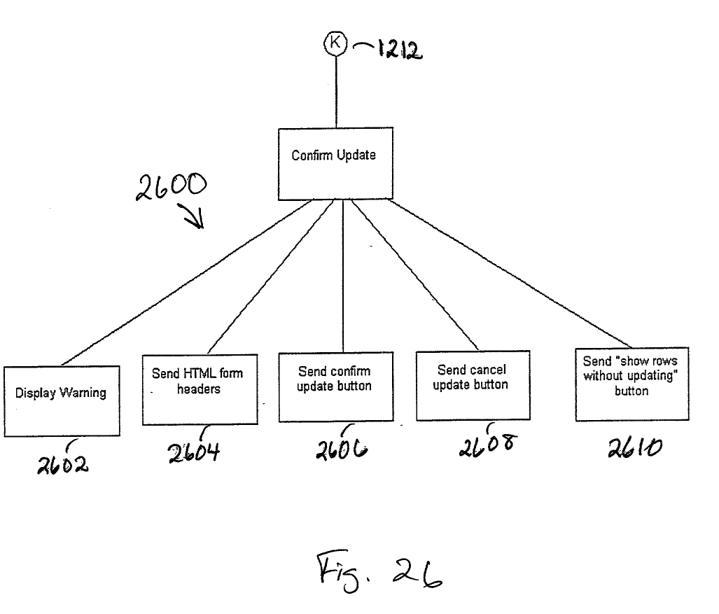

Moreover, the database management system confirmation functions can be accessed within the present database management system (100). Referring now to FIGS. 26-29, at step 1212, if the function is one of confirming an update then this function is initiated. If the function is a confirmation of a delete function, then accordingly, this function is accessed at step 1214. The function for the displaying of rows of data to be updated or deleted of is accessed at steps 1304 and 1306 respectively.

FIG. 26 is a flowchart illustrating a process 2600 related to the confirmation of an update function at step 1212. In order to notify a user of an updating action, the database server application (1207) initially transmits to, and at the web browser (110) displays a warning message at step 2602. Next, the database server application (107) transmits to the web browser HTML form headers at step 2604, interactive HTML confirmation update button at step 2606, interactive HTML cancel button at step 2608 and an interactive HTML “show rows without updating” button at step 2610.

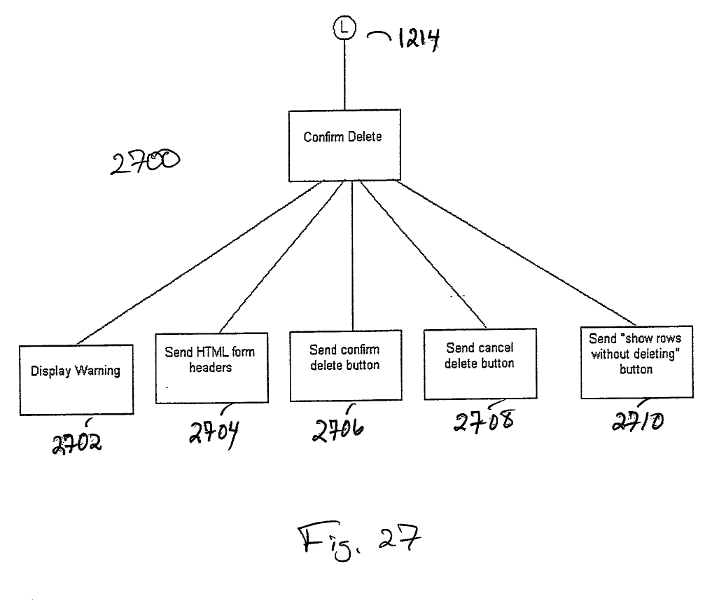

FIG. 27 is a flowchart illustrating a process 2700 related to the confirmation of a delete function at step 1214. In order to notify a user of a deleting action, the database server application (107) generates and transmits to the web browser (110) a warning message at step 2702. Next, the database server application (107) transmits to the web browser HTML form headers at step 2704, interactive HTML confirmation delete buttons at step 2706, interactive HTML cancel button at step 2708 and an interactive HTML “show rows without deleting” button at step 2710.

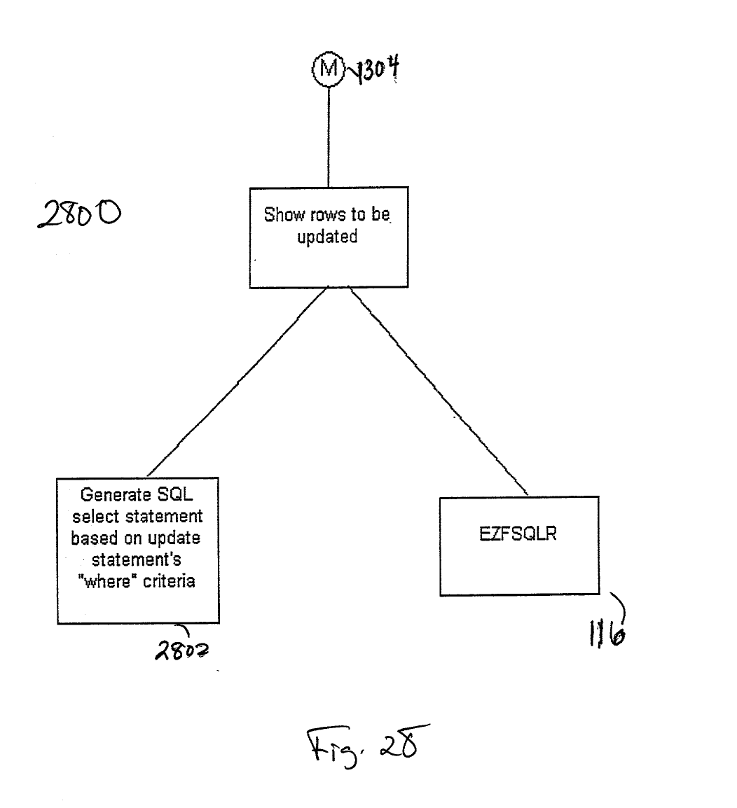

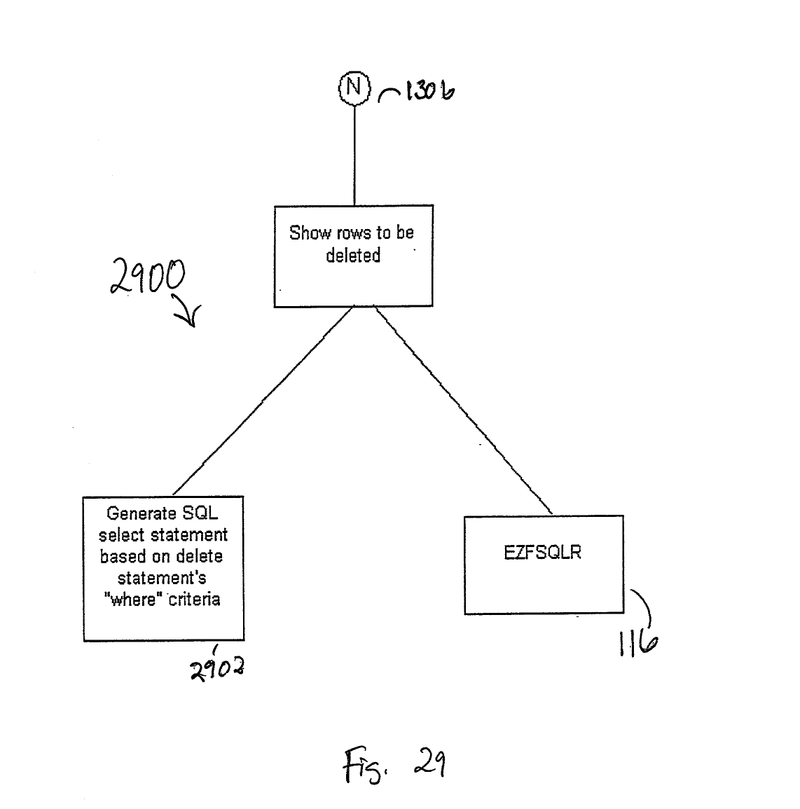

FIGS. 28 and 29 are flowcharts that illustrate processes 2800 and 2900 that are related to the functions for the displaying of rows of data to be updated or deleted, the functions being accessed at steps 1304 and 1306, respectively. As shown in FIG. 28 the database server application (107) generates a SQL statement that is based upon the update statement's “where” criteria at step 2802. Once this step is accomplished, the results are transmitted to the form SQL result function (116) and displayed to the user at the web browser (110).

Likewise, as shown in FIG. 29, the database server application (107) generates a SQL statement that is based upon the delete statement's “where” criteria at step 2902. Once this step is accomplished, the results are transmitted to the form SQL result function (116) and displayed to the user at the web browser (110).

Form clearing functions can be accomplished within the present database management system (100), as illustrated in FIGS. 13 and 14. Steps 1308, 1310, 1312 and 1314, respectively, correspond to the clear select, insert, update, and delete SQL forms.

Processes related to SQL repository functions that can also be initiated within the form-based function component of the present invention are illustrated in FIGS. 14 and 15, respectively. The SQL repository save as function is accessed at step 1408, the re-save function at step 1410, the delete function at step 1412, the delete confirmation function at step 1414, the cancel delete function at step 1502 and the step 1504 search functions are initiated within the database management system (100).

In the instance that a variable prompt is necessitated, the function of step 1508 is initiated. The user is prompted at step 1506 to enter user variable values and thereafter the database server application (107) initiates step 1114 and executes the SQL statement to which the variables were input.

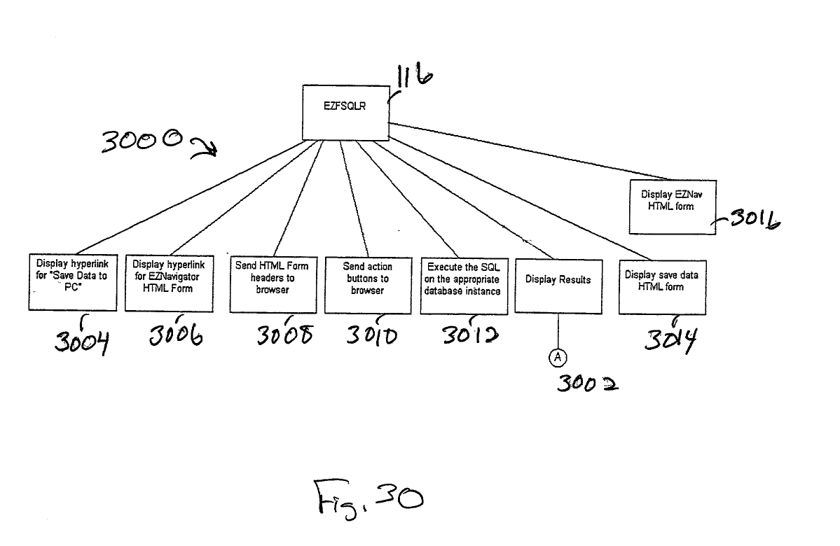

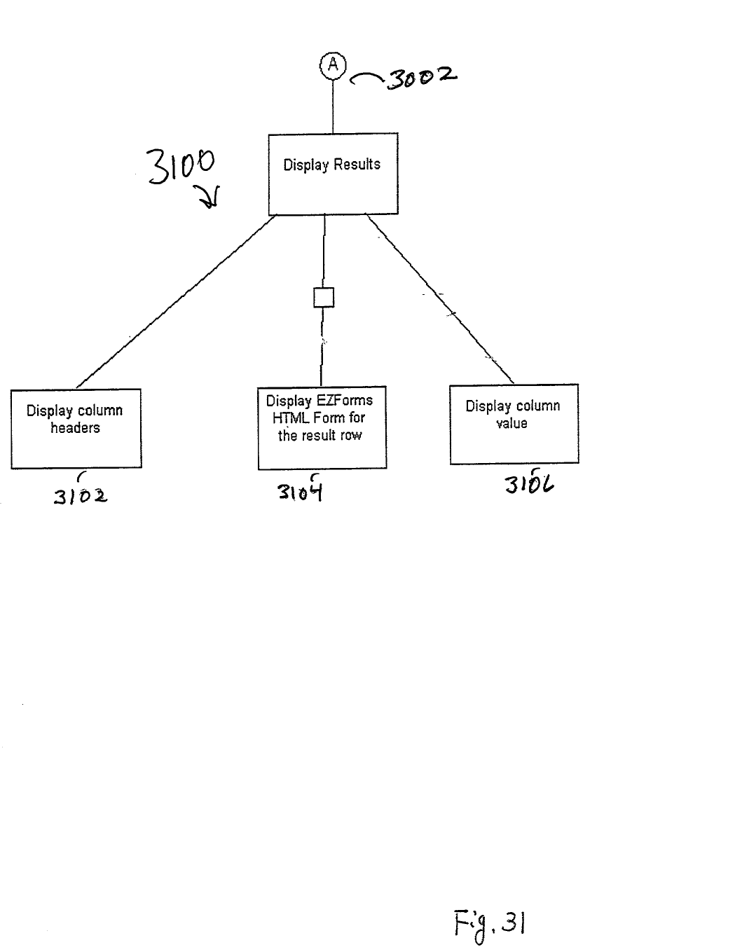

FIGS. 30-31 are flowcharts that illustrate the processes 3000, 3100 related to the database management system's (100) method of handling and processing results of SQL Select queries, respectively. Upon initiation of the database management system's (100) SQL select queries function (116), a series of system specific information is displayed at the web browser. At step 3004, a hyperlink that states “Save Data to PC” is generated by the database server application (107) and transmitted to the web browser (110) for display to the user. While at step 3006, the database server application (107) generates and transmits for display to the web browser (110) a hyperlink that will enable a user to return to the database management system's (100) database navigation function (112). The HTML header information is transmitted to the web browser at step 3008, and at step 3010 the action buttons form the HTML form are generated and transmitted to the browser. At step 3012, the database server application (107) generates and executes SQL on the appropriate database instance. The results of each row of data are displayed at step 3002. The column headers are returned at step 3102. If the form row variable function is activated within the database management system (100) then the database server application (107) generates and displays an HTML form for the resulting row at step 3104 and displays the column value for each column at step 3106.

If the user selects the “Save Data to PC” hyperlink, then the database server application (107) generates and returns a save data HTML form to the web browser at step 3014. Similarly, if the user selects the navigator hyperlink to return the navigator function, then the navigator HTML form at step 3016 is displayed.

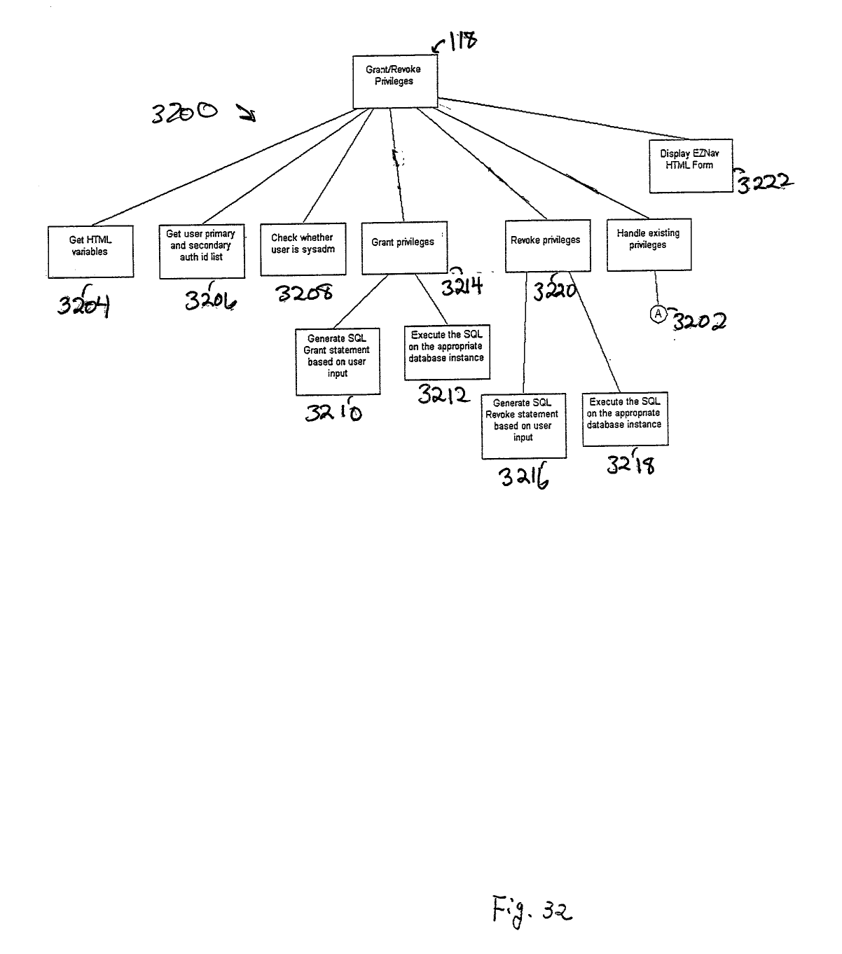

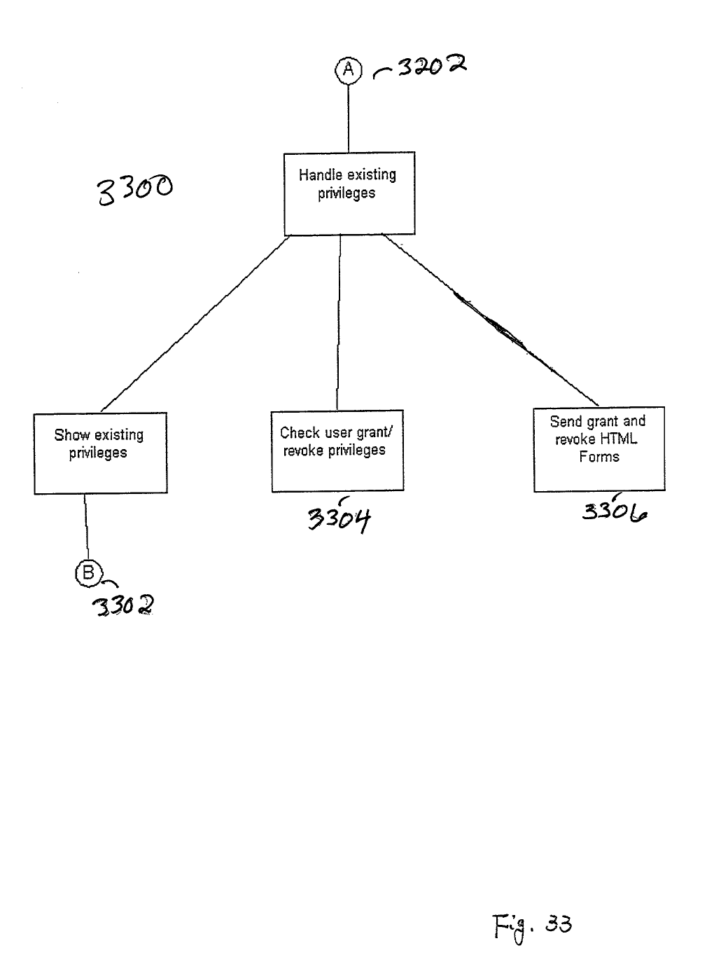

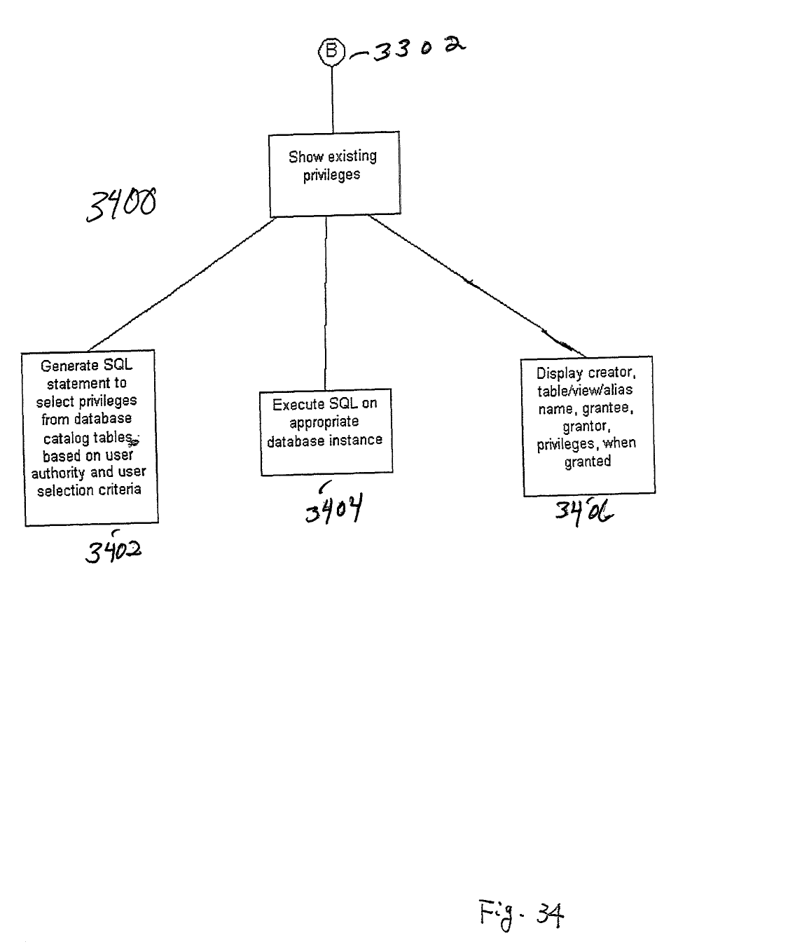

FIGS. 32-34 are flowcharts illustrating the processes 3200, 3300 and 3400, related to the grant/revoke privileges function (118) of the present invention, respectively. The function is initiated at step 3204, whereupon the database server application (107) obtains the HTML variables in regard to the function. At step 3206 the database server application (107) obtains the user's primary and secondary authorization identification list. Next, at step 3208, the database server application (107) verifies whether or not the user is a database management system (100) administrator. If the user initiates a grant function, then at step 3214 the database server application (107) initiates a grant privileges function. At step 3210 the database server application (107) generates a SQL grant statement based on the user input and execute the SQL statement at step 3212. If the user initiates a revoke function at step 3220, then at step 3216 the database server application (107) generates a SQL revoke statement based upon the user input and summarily executes the SQL statement on the appropriate database instance at step 3218. Step 3202 allows for the user to access and handle existing privilege data. Upon the completion of step 3202, at step 3222, the navigator function form is displayed to the user at the web browser (110).

Information regarding a user's existing database privilege data is displayed to a user at step 3302. This step further includes the steps of 3402, wherein the database server application (107) generates SQL statements that select privilege data from database catalog tables based upon the user's authority and step 3404, wherein the database server application (107) executes the SQL statements on the appropriate database instance. For each row of data, at step 3406, the creator, table/view/alias, name, grantee, grantor, privileges and the date when granted is displayed to the user at the workstation web browser (110). Next, at step 3304, the database server application (107) checks the user's privilege to grant or revoke authorization access to authorized data. At step 3306, if the database server application determines a user has system administration authority or grant/revoke privileges, then the database server (108) transmits the appropriate grant or revoke privileges HTML form to the user and displays the information on the workstation web browser (11O).

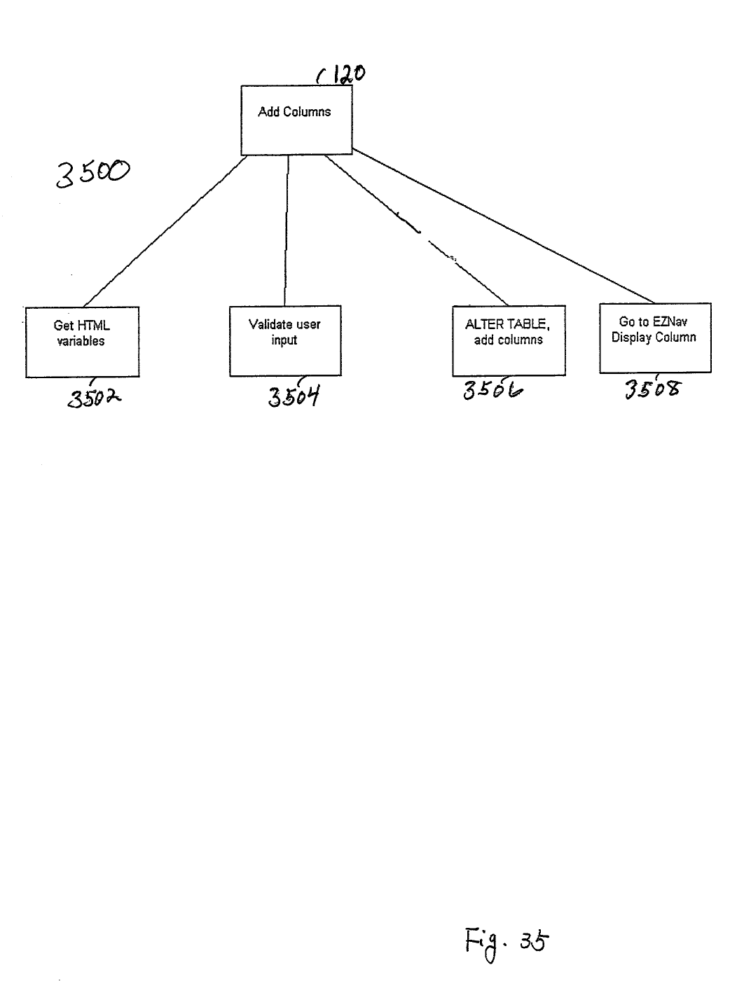

FIGS. 35 is a flowchart illustrating a process 3500 of adding a column to a program-generated table of step 120. The process is initiated by the database server application (107) obtaining user submitted HTML variables at step 3502. The user input is validated at step 3504, and if it is determined that the input is valid, the database server application (107) alters the table by the addition of columns at step 3506. Subsequently, the database server application (107) returns to the navigator function and displays the columns to the user at step 3508.

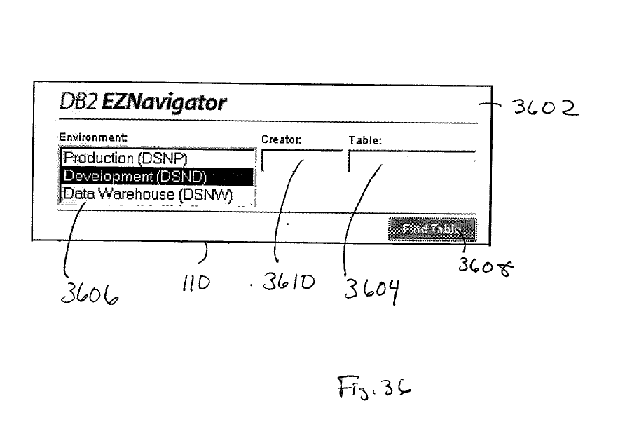

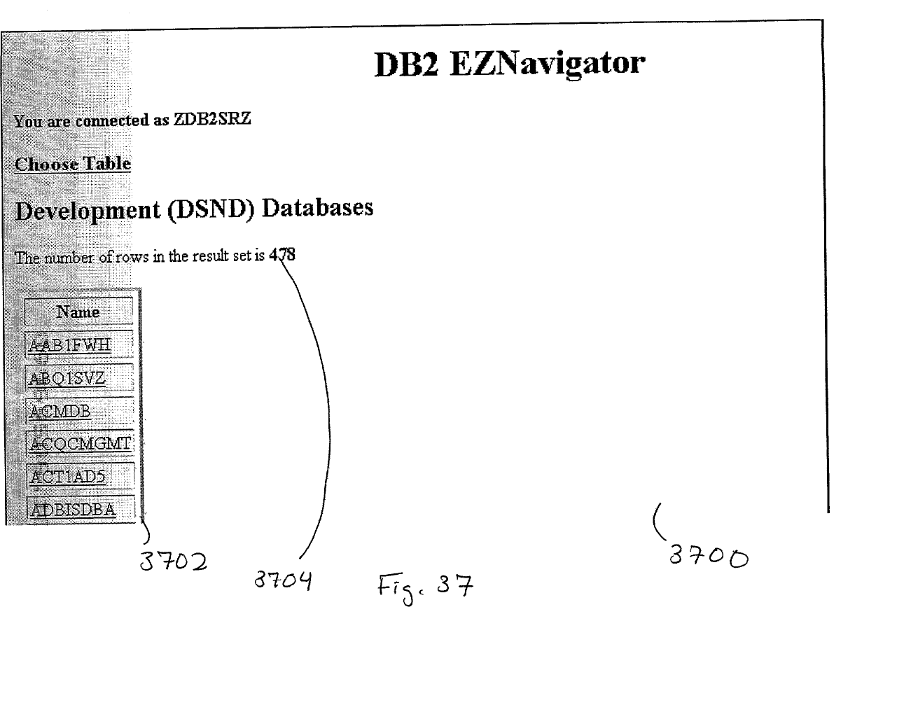

A further embodiment of the present invention is presented in reference to FIGS. 36-42. In FIG. 36, the database management system's (100) navigator function (112) is displayed to the user as an HTML database navigation form (3602) at the web browser (110). A navigator function is initiated by a user clearing the creator (3610) and table fields (3604) and selecting the development listing that is listed within the database environment field (3606). Next, the user clicks on the HTML submit button (3608). As a result of clicking on the HTML submit button (3608), the database server application (107) generates a SQL statement to query the data dictionary. In FIG. 37, the results of the query are returned to the web browser (110) in the HTML database navigation form (3700), as a hyperlink listing of accessible databases (3702). Additional information can also be obtained. For example, part of the text portion (3704) in the HTML database navigation form (3602) provides that there are 478 rows in the accessible database (3702).

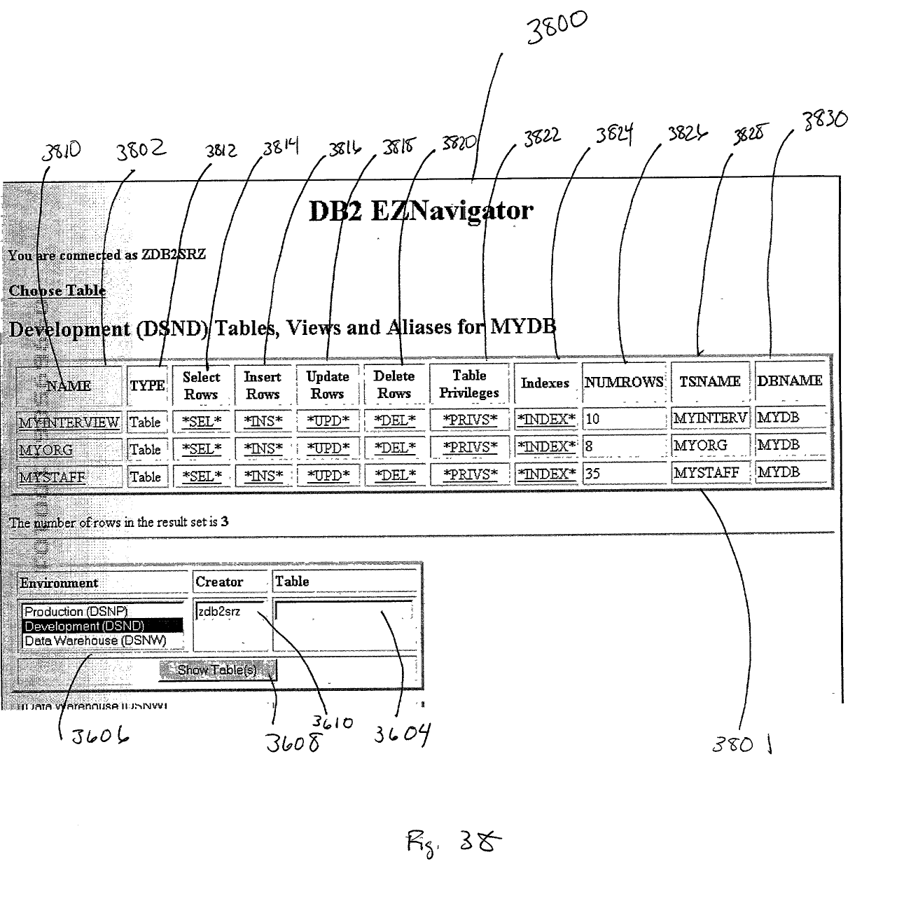

The user can scroll through the hyperlink listing of accessible databases (3702) and click on a particular hyperlinked database item. When doing so, the database server application (107) generates a SQL statement to query the data dictionary and returns a revised HTML database navigation form (3800) to the web browser (110). At FIG. 38, the HTML navigation form (3800) displays a HTML table that lists the objects that are accessible in the chosen database (3802) that is selected from the database list (3702). The HTML table (3801) contains hyperlink listings of the object name (3810), type (e.g., table, view, alias, etc.) (3812) in addition to hyperlinks to system functions such as a select row function (3814), an insert row function (3816), an update row function (3818), a delete row function (3820), table privilege information (3822) and data indexes (3829). Additional listed information includes, but not limited to, the number of rows contained within a listed table (3826), the table source name (3828) and the source database name (3830).

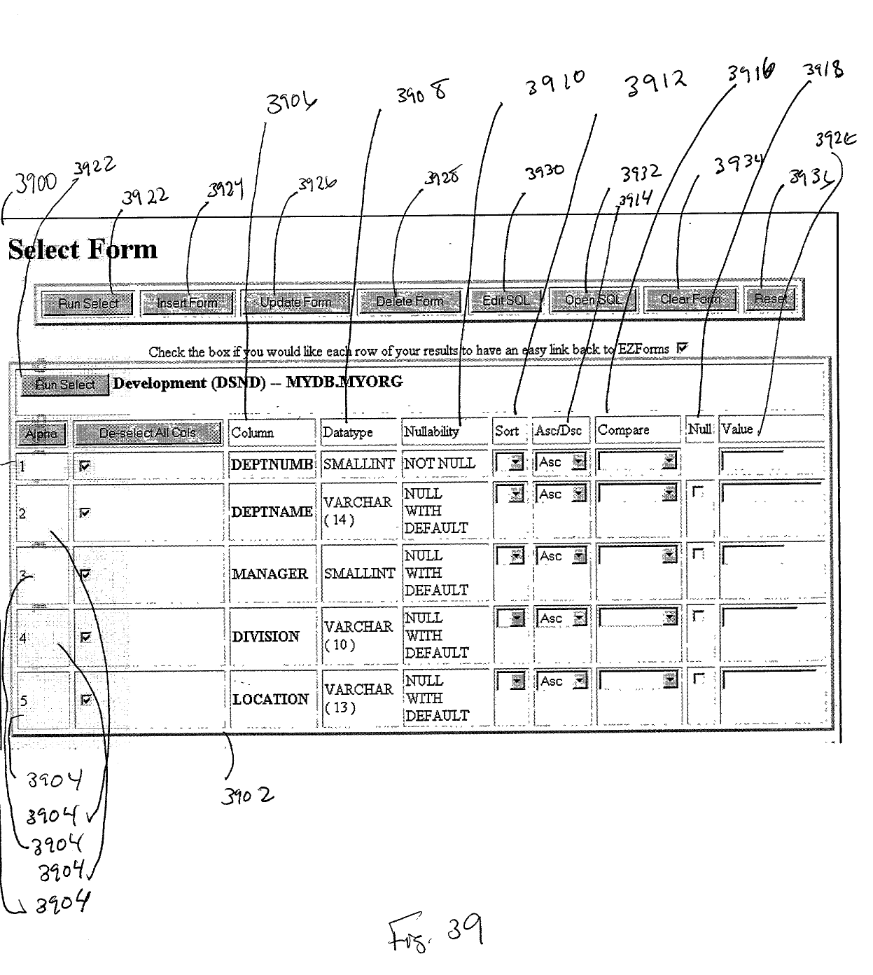

Next, the user may click on the “SEL” hyperlink (3814) for one of the objects that is defined as a table, as illustrated in FIG. 38. Accordingly, the database server application (107) initiates the interactive HTML form-based function and thereafter generates a SQL statement to query the data dictionary and in FIG. 39, returns a HTML form (3900) to the web browser (110) that can be utilized to request rows of data (3904) to be returned from the table (3810). The HTML form (3900) automatically displays information in a HTML table (3902) in regard to the columns (3906) that are defined in the table (3810), including but not limited to information pertaining to their data types (3908), nullability (3910) and row sort order (3912). Additionally, the HTML form (3902) contains function buttons that enable a user to initiate additional tasks within the database management system. These buttons include “Run Select” button (3922), “Insert Form” button (3924), “Update Form) button (3926), “Delete Form” button (3928), “Edit SQL” button (3930), “Open SQL” button (3932), “Clear Form” button (3934) and “Reset” button (3936). Each button can be selected or clicked to perform a corresponding action.

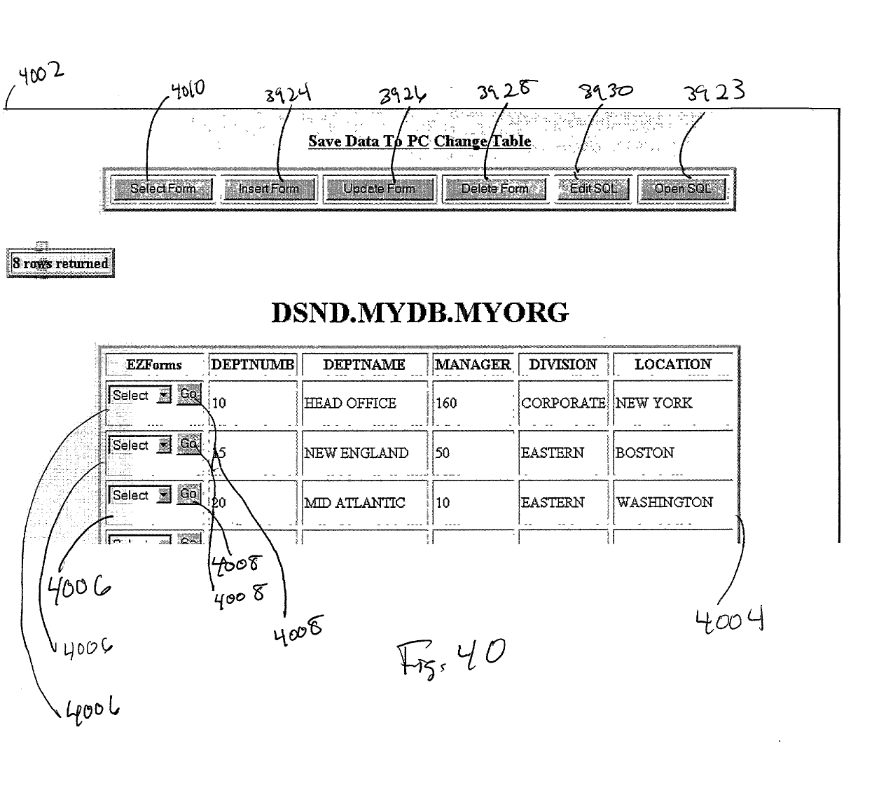

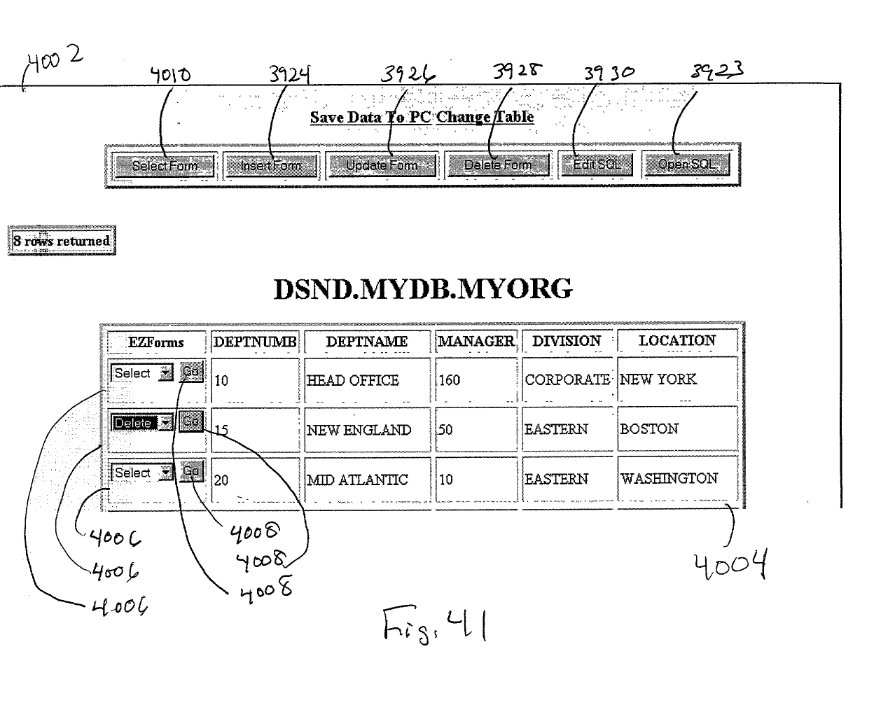

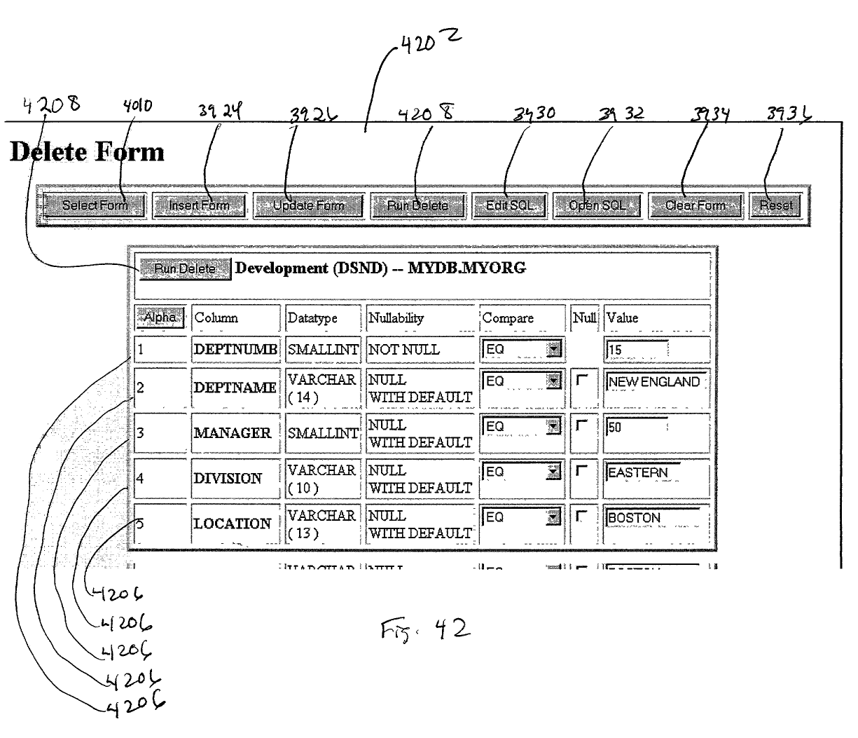

For example, a user may click on the “Run Select” button (3922) as shown in FIG. 39. The database server application (107) generates a SQL statement to query the data dictionary and returns the results of the search in a HTML form (4002) as shown in FIG. 40. The query results are displayed as a series of rows in a HTML table (4004) on the HTML form (4002). The form data field (4006) of the HTML form (4002) presents the user with the option of selecting a function that can be utilized to process selected data. In FIG. 41, the user selects the “delete” function from the form field (4006) of the HTML form (4002) for the second row of returned data, and then clicks on the submit button (4008). The database server application (107) builds a SQL a statement to query the data dictionary and returns the query results in a HTML delete function form (4202), as shown in FIG. 42, that can be used to delete a row of data (4206). Lastly, the user clicks on the “Run Delete” button (4208) of FIG. 42. The database server application (107) builds a SQL statement based upon the information contained within the HTML delete form (4202) and submits the SQL statement to the database engine, which deletes the selected row of data.

Other aspects of the invention may be found from the attached drawings and other related materials such as a detailed review of the various functions offered by a database of the present invention, which are integral parts of this disclosure. Moreover, other embodiments of the invention will be apparent to those skilled in the art from consideration of the specification and practice of the invention disclosed herein. It is intended that the specification and examples be considered as exemplary only.

What is claimed:

1. A database management system for managing relational data, comprising:
one or more remote database storage facilities;
a database server computer executing a database server application that manages access to one or more database storage facilities, wherein the server computer is in communication with the one or more remote database storage facilities; and
a computer workstation in communication with the server computer, wherein the computer workstation executes a remote accessing program in the form of a web browser to access via the server computer data stored in the one or more remote database storage facilities.

2. The system of claim 1, wherein the database server application generates commands in HTML or SQL.

3. The system of claim 2, wherein the one or more remote database storage facilities have a data dictionary corresponding to the data stored therein, and upon a request for data from the web browser the database server application generates a series of commands in SQL to query the data dictionary of the remote storage facilities.

4. The system of claim 3, wherein upon a request for data from the web browser the database server application automatically generates commands in HTML to select and display at the web browser a listing of the data that is contained in the data dictionary that is stored within the database.

5. The system of claim 4, wherein the requested data is displayed in an hyperlink HTML format.

6. The system of claim 4, wherein the requested data is displayed on the web browser in an interactive format to allow a computer workstation user to edit data displayed on the web browser.

7. The system of claim 6, wherein the displayed data that is edited by the computer workstation user is submitted and stored at the remote database storage facility.

8. The system of claim 7, wherein the database server application generates commands in SQL to select, insert, update or delete any selected data that is submitted in HTML format to the server computer via the web browser.

9. The system of claim 3, wherein the data stored in the data dictionary comprises data tables.

10. The system of claim 3, wherein the data stored in the data dictionary comprises information corresponding to an individual user's access right to data stored therein.

11. A computerized system for managing relational data over a network, comprising:
a computer readable medium;
a server computer;
a computer workstation in communication with the server computer;
a database storage facility in communication with the server computer; and
a computer program encoded on the computer readable medium, wherein the computer program is operative when in operative association with the server computer to access, create and manage relational data stored within the remote database storage facility over a network.

12. The system of claim 11, wherein the computer program is operable to generate commands in SQL to query the remote database storage facility and generate an HTML listing of items stored within the remote database storage facility that are displayed at the workstation, wherein each item is displayed as an HTML hyperlink.

13. The system of claim 12, wherein upon the selection of a hyperlink database item, the computer program is operable to generate commands in SQL to query the remote database facility, and data resulted from the query is returned and displayed in HTML.

14. The system of claim 13, wherein the data resulted from the query comprises tables, views and aliases.

15. The system of claim 11, wherein the computer program is further operable to allow a computer workstation user to select an item that is displayed in as an HTML hyperlink, whereupon the selection of a hyperlinked item, the computer program is operable to generate SQL commands to query the remote database storage facility in regard to the item that was chosen, and to generate and display at the computer workstation an interactive HTML form that contains data corresponding to the item that was selected.

16. The system of claim 15, wherein the interactive HTML form is displayed to the computer workstation user and provides the computer workstation user with an option of executing a select, insert, update or delete function upon the data that is displayed in the interactive HTML form.

17. The system of claim 16, wherein if the user executes an insert, update or delete function upon the displayed data, the computer program is operable to generate commands in SQL for the insert, updating or deletion function, respectively execute commands in SQL upon the displayed data and display the result of the function to the user in an HTML form.

18. The system of claim 16, wherein if the user executes a select function, the computer program is operable to generate and execute commands in SQL for the select function and return the results of the select function to the user in an HTML form.

19. The system of claim 11, wherein the database storage facility is either a local database storage facility or a remote database storage facility.

20. A method for managing a database for relational data over a network, comprising the steps of:
accessing a database that is in communication with the network;
managing data stored in the database with a database management system; and
storing changes made to stored data stored in the database.

21. The method of claim 20, wherein the step of accessing the database includes the step of accessing the database from a computer workstation that is in communication with the network.

22. The method of claim 21, wherein the step of accessing the database includes the step of displaying a list of objects that are stored within the database.

23. The method of claim 22, wherein the step of accessing the database includes the step of restricting a user to accessing data that is related to the objects of which the user has access privileges.

24. The method of claim 23, wherein the step of accessing the database includes the step of viewing and changing object access privileges to the objects to which the user has access privileges.

25. The method of claim 20, wherein the step of managing data stored in the database includes the step of generating and displaying an HTML form at a display device, wherein the HTML form can be utilized to select object data from the database.

26. The method of claim 25, wherein the step of managing data within the database includes the step of generating and displaying an HTML form at a display device, wherein the HTML form can be utilized to insert object data into the database.

27. The method of claim 25, wherein the step of managing data within the database includes the step of generating and displaying an HTML form at a display device, wherein the HTML form can be utilized to edit object data that is stored in the database.

28. The method of claim 25, wherein the step of managing data within the data base includes the step of generating and displaying an HTML form at a display device, wherein the HTML form can be utilized to update object data that is stored in the database.

29. The method of claim 25, wherein the step of managing data within the database includes the step of generating and displaying an HTML form at a display device, wherein the HTML form can be utilized to delete object data that is stored in the database.

30. A method for operating a computerized system for managing relational data over a network, comprising:
remotely accessing a database server with a web browser;
utilizing HTML forms to gather data and transmitting form data to the database server; and
displaying HTML form that contains the gathered data.

31. The method of claim 30, further comprising the step of utilizing the HTML form to request a listing of database objects that are stored in a database storage device.

32. The method of claim 31, further comprising the step of generating commands in SQL to query a data dictionary of the database storage device in response to the request for a listing of stored database objects.

33. The method of claim 32, further comprising the step of displaying at a computer workstation an HTML form that contains a listing of databases that are stored in the database storage device, wherein each accessible database in the system that is listed is displayed in an HTML hypertext linking format.

34. The method of claim 33, further comprising the step of scrolling through the listing of HTML hypertext links of accessible database objects.

35. The method of claim 34, further comprising the step of requesting data in a specific database by selecting a hyperlink of an accessible database object by clicking on the hyperlink listing of the database object.

36. The method of claim 35, further comprising the step generating commands in SQL to query the data dictionary of the database storage device in regard to the objects that are stored within the selected database.

37. The method of claim 36, further comprising the step of displaying an HTML form that contains a listing of the tables, views and aliases that are accessible in the selected database, wherein each listed item is in HTML hyperlink format.

38. The method of claim 37, further comprising the step of selecting from the hyperlink listing of items a table, view or alias.

39. The method of claim 38, further comprising the step of generating SQL commands to query the data dictionary of the database storage device in regard to selected tables, views or aliases.

40. The method of claim 39, further comprising the step of displaying an HTML form, wherein the form contains data that is representative of the columns that are defined in a selected table, the data type of the selected item.

41. The method of claim 40, further comprising the step of specifying the sort order and search criteria for the data that is returned from the database storage device.

42. The method of claim 41, further comprising the step of submitting the sort order and search criteria query to the system, wherein the system returns and displays an HTML form that contains the selected data.

43. The method of claim 42, further comprising the step of providing to a user an option to insert, delete or update data that is selected by the user.

44. The method of claim 43, further comprising the step of generating commands in SQL to query the data dictionary in regard to the data that was selected for the insert, delete or updating function.

45. The method of claim 44, farther comprising the step of returning an HTML form to the computer workstation that can be used to insert, delete or update the selected data.

46. The method of claim 45, farther comprising the step of submitting the HTML form containing the edited data to the database server.

47. The method of claim 46, further comprising the step of generating commands in SQL based on information contained within the HTML form and submits the commands in SQL to a database engine, wherein the engine performs the requested editorial function of inserting, deleting or updating the selected data within the database storage device.

48. The method of claim 30, wherein the database storage device comprises a memory.

49. The method of claim 30, wherein the network is the Internet.

50. The method of claim 30, wherein the network is a network in communication with the Internet.
